(19) United States
(12) Patent Application Publication
(10) Pub. No.: US 2026/0274178 A1
(43) Pub. Date: Sep. 17, 2026

(54) VEHICLE INTERIOR COMPONENT

(71) Applicant: Yanfeng International Automotive Technology Co. Ltd., Novi, MI (US)

(72) Inventors: Sihan YU, Shanghai (CN); Tianfu YAN, Shanghai (CN); Qi GAO, Shanghai (CN); Ping ZHAO, Shanghai (CN); Leilei DENG, Shanghai (CN)

(21) Appl. No.: 19/676,735

(22) Filed: May 13, 2026

Related U.S. Application Data
(63) Continuation-in-part of application No. PCT/CN2024/130474, filed on Nov. 6, 2024.

(30) Foreign Application Priority Data
Nov. 14, 2023 (CN) 202323069047.7

(51) Int. Cl. B60R 13/02; B60Q 3/14

(52) U.S. Cl. CPC B60R 13/0256; B60Q 3/14; B60R 13/0243; B60R 13/025

(57) ABSTRACT

A component for a vehicle interior comprising a composite structure is disclosed. The composite structure comprises a base layer and cover layer; the cover layer comprises an exterior surface; the cover provides a surface effect for the exterior surface comprising a visual effect and/or performance effect; the visual effect comprises a decorative effect such as texture, grain, wood, metallic, etc.; the cover comprises an applied/deposited material such as a coating, paint, ink, film, etc. The base layer may comprise wood material/veneer. A light source may be configured to provide illumination for the cover; the cover may comprise light-transmissive material. The cover may comprise a feature such as a line, strip, inlay, layer, etc. as a decorative feature; the feature may comprise a layer of material at the cover layer and/or within the cover; the feature may be illuminated by the light source. A method of producing the component is disclosed.

### CROSS-REFERENCE TO RELATED APPLICATIONS

The present application is a continuation-in-part of PCT/International Patent Application No. PCT/CN2024/130474 titled “REAL WOOD TRIM AND METHOD FOR MANUFACTURING REAL WOOD TRIM” filed Nov. 6, 2024, that claims the benefit of Chinese Patent Application No. 2023069047.7 titled “REAL WOOD DECORATION” filed Nov. 14, 2023.

The present application claims priority to and incorporates by reference in full: (1) PCT/International Patent Application No. PCT/CN2024/130474 titled “REAL WOOD TRIM AND METHOD FOR MANUFACTURING REAL WOOD TRIM” filed Nov. 6, 2024; and (2) Chinese Patent Application No. 2023069047.7 titled “REAL WOOD DECORATION” filed Nov. 14, 2023.

### FIELD

The present application relates to a vehicle interior component.

The present application relates to a vehicle interior component configured to provide a visual effect.

### BACKGROUND

According to an exemplary embodiment, the component comprising the composite structure is known to provide a vehicle interior component to configured to provide a visual effect such as a wood trim effect and/or a metal trim effect.

According to an exemplary embodiment, the component comprising the composite structure would be advantageous to provide an improved vehicle interior component comprising a cover configured to provide a visual effect such as a wood trim effect and/or a metal trim effect.

According to an exemplary embodiment, the component comprising the composite structure would be advantageous to provide an improved vehicle interior component comprising a cover comprising a base layer and a cover layer configured to provide a visual effect such as a wood trim effect and/or a metal trim effect.

According to an exemplary embodiment, the component comprising the composite structure would be advantageous to provide an improved vehicle interior component comprising a cover comprising a base layer and a cover layer configured to be produced by an efficient manufacturing process and configured to provide a visual effect such as a wood trim effect and/or a metal trim effect.

### SUMMARY

The present invention relates to a component for a vehicle interior comprising a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the surface effect may be provided at the exterior surface of the cover and/or under the exterior surface of the cover; the visual effect may comprise a decorative effect for the cover; the cover may comprise a material comprising an applied material and/or a deposited material and/or a coating and/or a paint and/or an ink material and/or a deposited material and/or a film. The base layer may comprise a wood material and/or a veneer and/or a wood veneer. The component may comprise a light source configured to provide illumination at the cover of the composite structure; the cover may comprise a light guide and/or a light-transmissive material. The base layer may comprise a light-transmissive material comprising a wood veneer material. The composite structure may comprise a substrate for the cover. The cover may comprise a feature configured to provide the surface effect; the feature may comprise a line and/or a strip and/or a layer and/or a trim strip and/or a trim line and/or a decorative feature and/or a decorative line and/or an inlaid material and/or a set of lines and/or a set of strips and/or a set of layers and/or a set of trim strips and/or a set of trim lines. The feature may comprise a layer of material and/or an applied material and/or a deposit of material. The feature may comprise a decorative feature at the cover layer of the cover and/or on the exterior surface of the cover and/or within the cover and/or on the base layer of the cover and/or under the base layer of the cover and/or a decorative feature configured to be illuminated by a light source and/or a trim strip and/or a decorative line and/or a trim line configured to be illuminated by a light source. The visual effect may comprise an illumination effect and/or a color effect and/or a gloss effect and/or a luster effect and/or a dynamic decorative effect and/or an illumination effect and/or a dynamic illumination effect and/or a texture effect and/or a grain effect and/or a gloss effect and/or a contrast effect and/or a wood grain effect and/or a metallic effect and/or a trim strip effect and/or a divider line effect and/or an inlaid appearance effect and/or a metal-like appearance effect and/or a wood-like appearance effect and/or an embedded metallic appearance effect. The decorative effect may comprise a static effect and/or a dynamic effect and/or a texture effect and/or a color effect and/or a luster effect and/or a gloss effect and/or a matte effect and/or a grain effect and/or a wood grain effect and/or a metal effect and/or a metallic texture effect. The performance effect may comprise protection for the exterior surface and/or a tactile effect and/or a texture effect. The cover may comprise a paint layer and/or a coating layer and/or a PVD layer and/or an ink layer and/or a light-transmissive layer and/or a mask layer and/or an opaque layer. The cover may comprise at least one facet at the exterior surface configured to provide a visual effect and/or at least one section at the exterior surface configured to provide a plurality of visual effect. The cover may comprise a feature between each facet of the exterior surface and/or each section of the exterior surface; the feature may comprise a trim strip and/or a divider line. The base layer may comprise a molded layer comprising a polymer material and/or a molded material and/or an injection molded material and/or a film and/or a polymer material and/or an elastomer and/or a thermo-resin elastomer and/or a resin layer and/or a substrate section and/or a structural section and/or a light-transmissive section and/or an opaque section and/or a non-light-transmissive section and/or an opaque section and a light-transmissive section and/or a resin substrate layer and/or an opaque resin substrate layer. The decorative effect of the cover may comprise a metallic decorative effect and/or a wood grain effect. The cover layer of the cover may comprise a coating and/or an ink layer and/or a coating layer and/or a treatment layer and/or a protective layer and/or a light-transmissive coating layer and/or a paint layer and/or an ink layer and/or a PVD layer and/or a gloss layer and/or a color gloss layer and/or a metal color layer and/or a metallic ink layer and/or a printed metallic ink layer. The cover may be configured to provide the visual effect as an ambient effect when cover is unilluminated by the light source and the visual effect as an illuminated effect when the cover is illuminated by the light source. The surface effect of the composite structure is configured to comprise a wood grain effect and/or a gloss effect when unilluminated by the light source and a metallic effect and/or a reflective effect when illuminated by the light source. The component may be produced by a method comprising the steps of: providing a base layer material for the base layer of the cover; providing a cover layer material for the cover layer of the cover on the base layer of the cover; the step of providing the cover layer material on the base layer may comprise forming the cover layer on the base layer; the cover layer material may comprise at least one of a coating and/or a paint layer and/or an ink layer and/or a PVD material and/or a deposited material and/or an applied material and/or a spray-applied material; the cover is configured to provide the surface effect for the composite structure. The component may be produced by a method comprising the steps of: providing a base layer material for the base layer of the cover; providing a cover layer material for the cover layer of the cover on the base layer of the cover; providing the feature for the cover; the step of providing the cover layer material on the base layer may comprise forming the cover layer on the base layer; the cover layer material may comprise at least one of a coating and/or a paint layer and/or an ink layer and/or a PVD material and/or a deposited material and/or an applied material and/or a spray-applied material; the cover is configured to provide the surface effect for the composite structure; the feature may comprise a trim line configured to provide the decorative effect for the cover.

The present invention relates to a component for a vehicle interior comprising: a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the surface effect may be provided at the exterior surface of the cover and/or under the exterior surface of the cover; the visual effect may comprise a decorative effect for the cover; the cover may comprise a material comprising an applied material and/or a deposited material and/or a coating and/or a paint and/or an ink material and/or a deposited material and/or a film. The base layer may comprise a wood material and/or a veneer and/or a wood veneer. The component may comprise a light source configured to provide illumination at the cover of the composite structure; the cover may comprise a light guide and/or a light-transmissive material. The base layer may comprise a light-transmissive material comprising a wood veneer material. The composite structure may comprise a substrate for the cover. The cover may comprise a feature configured to provide the surface effect; the feature may comprise a line and/or a strip and/or a layer and/or a trim strip and/or a trim line and/or a decorative feature and/or a decorative line and/or an inlaid material and/or a set of lines and/or a set of strips and/or a set of layers and/or a set of trim strips and/or a set of trim lines. The feature may comprise a layer of material and/or an applied material and/or a deposit of material. The feature may comprise a decorative feature at the cover layer of the cover and/or on the exterior surface of the cover and/or within the cover and/or on the base layer of the cover and/or under the base layer of the cover and/or a decorative feature configured to be illuminated by a light source and/or a trim strip and/or a decorative line and/or a trim line configured to be illuminated by a light source. The cover may comprise at least one facet at the exterior surface configured to provide a visual effect and/or at least one section at the exterior surface configured to provide a plurality of visual effect. The feature of the cover may be provided between each facet of the exterior surface and/or each section of the exterior surface. The decorative feature may comprise a visual line for the cover and/or a decorative line for the composite structure and/or a trim line and/or a surface layer on the cover and/or an intermediate layer in the cover and/or an intermediate layer under the cover and/or a straight line and/or a set of lines for the cover and/or a feature configured to be illuminated and/or a surface layer material and/or an inlaid material and/or an intermediate layer material. The cover may comprise an intermediate layer configured to provide the surface effect. The visual effect may comprise an illumination effect and/or a color effect and/or a gloss effect and/or a luster effect and/or a dynamic decorative effect and/or an illumination effect and/or a dynamic illumination effect and/or a texture effect and/or a grain effect and/or a gloss effect and/or a contrast effect and/or a wood grain effect and/or a metallic effect and/or a trim strip effect and/or a divider line effect and/or an inlaid appearance effect and/or a metal-like appearance effect and/or a wood-like appearance effect and/or an embedded metallic appearance effect. The cover may comprise a feature between each facet of the exterior surface and/or each section of the exterior surface; the feature may comprise a trim strip and/or a divider line and/or an appearance of metal embedded in a cover material and/or an appearance of metal embedded in veneer and/or an appearance of metal embedded in wood veneer and/or a wood appearance from a wood material and/or a wood appearance from a non-wood material and/or a metal appearance from a non-metal material and/or a natural/real wood inlaid metal appearance and/or a metallic decorative effect and/or a metallic decorative strip effect and/or a metallic decorative effect when the component is unilluminated by the light source and/or an illuminated metallic decorative effect when the component is illuminated by the light source and/or a wood grain effect combined with a metallic effect and/or a wood grain effect combined with a metallic light transmitting effect. The decorative effect may comprise a static effect and/or a dynamic effect and/or a texture effect and/or a color effect and/or a luster effect and/or a gloss effect and/or a matte effect and/or a grain effect and/or a wood grain effect and/or a metal effect and/or a metallic texture effect. The performance effect may comprise protection for the exterior surface and/or a tactile effect and/or a texture effect. The cover may comprise a paint layer and/or a coating layer and/or a PVD layer and/or an ink layer and/or a light-transmissive layer and/or a mask layer and/or an opaque layer. The cover layer may be formed on the base layer; the cover layer may comprise a film and/or a coating and/or an exterior layer and/or an applied layer and/or a formed layer and/or a molded layer and/or a coating layer; and/or a treatment layer and/or a veneer layer and/or a wood layer and/or a wood veneer layer and/or a light-transmissive veneer layer and/or a light-transmissive wood veneer layer and/or a coating layer comprising at least one of a paint layer or a PVD layer or an ink layer and/or a light guide material and/or a light-transmissive material and/or a mask and/or a shielding layer and/or a plurality of cover surface regions configured to provide a plurality of visual effects and/or a trim line and/or a decorative line and/or an illuminated line and/or a divider line and/or a line between adjacent cover surface regions and/or a trim line configured to provide a metallic visual effect; and/or a trim line configured to transmit light and/or trim and/or trim at an edge of the composite structure and/or trim configured to provide a metallic visual effect and/or trim configured to provide an illuminated visual effect. The cover may comprise a wood veneer layer and/or a light-transmissive wood veneer layer and/or a coating layer and/or an ink layer. The base layer may comprise a molded layer comprising a polymer material and/or a molded material and/or an injection molded material and/or a film and/or a polymer material and/or an elastomer and/or a thermo-resin elastomer and/or a resin layer and/or a substrate section and/or a structural section and/or a light-transmissive section and/or an opaque section and/or a non-light-transmissive section and/or an opaque section and a light-transmissive section and/or a resin substrate layer and/or an opaque resin substrate layer. The decorative effect of the cover may comprise a metallic decorative effect and/or a wood grain effect. The cover layer may comprise a coating comprising an ink layer and/or a coating layer comprising a treatment layer and/or a surface treatment layer and/or a protective layer and/or a light-transmissive coating layer and/or a light-transmissive protective layer and/or a paint layer and/or a layer configured to fill a texture of the wood veneer layer and/or a layer configured to fill a texture of the wood veneer layer and/or a layer configured to provide a flat exterior surface and/or a layer configured to protect the wood veneer layer and/or a layer configured to protect the ink layer and/or PVD layer. The cover layer may comprise an ink layer comprising a decorative gloss layer and/or a color gloss layer and/or a metal color gloss layer and/or a metallic gloss layer and/or a surface treatment layer and/or a coating and/or a metal-color coating and/or a metallic coating and/or a transfer layer and/or an ink transfer layer and/or a pad printing layer and/or an ink pad printing layer and/or a metallic ink layer and/or a printed metallic ink layer and/or a layer pad-printed on the wood veneer layer and/or a layer pad-printed on the coating layer. The cover is configured to provide the visual effect when the component is unilluminated by the light source and/or a light transmitting gloss effect when the component is illuminated by the light source and/or a static visual effect when the component is unilluminated by the light source and a dynamic visual effect when the component is illuminated by the light source. The cover layer may comprise a deposited layer comprising a PVD layer comprising a vapor deposited layer and/or a vacuum evaporation coating and/or a PVD coating layer and/or a PVD spray coating layer and/or a PVD film layer and/or a PVD membrane and/or a PVD diaphragm and/or a layer between the coating layer and the wood veneer layer and/or a layer between the wood veneer layer and the base layer and/or a layer between the base layer and a light-transmissive section and/or a layer configured to provide a metallic decorative effect. The ink layer and/or the PVD layer may be on the coating layer and/or at the exterior surface and/or between the coating layer and the wood veneer layer and/or at the exterior surface of the cover and/or under the coating layer and/or under the wood veneer layer and/or under the base layer and/or under a light-transmissive section of the base layer and/or aligned with a light-transmitting region of the cover and/or aligned with a light-transmissive section of the base layer. The ink layer and/or the PVD layer may comprise a decorative feature and/or a decorative line and/or a trim feature and/or a trim line and/or is at the trim. The surface effect of the composite structure may be configured to comprise a wood grain effect and/or a gloss effect when unilluminated by the light source and a metallic effect when illuminated by the light source. The substrate may comprise a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate; the component may comprise an instrument panel and/or a door panel and/or a console and/or a floor console and overhead console and/or an armrest and/or a trim insert and/or a trim panel and/or a trim component. The component may be produced by a method comprising the steps of: providing a base layer material for the base layer of the cover; providing a cover layer material for the cover layer of the cover on the base layer of the cover; the step of providing the cover layer material on the base layer may comprise forming the cover layer on the base layer; the cover layer material may comprise at least one of a coating and/or a paint layer and/or an ink layer and/or a PVD material and/or a deposited material and/or an applied material and/or a spray-applied material; the cover may be configured to provide the surface effect for the composite structure. The component may comprises a composite structure comprising a substrate comprising a structural substrate and a cover; the cover may comprise a base layer and a cover layer; the base layer may comprise a wood veneer layer; the cover layer may comprise a coating; the composite structure may comprise a visual effect for the cover comprising a natural/real wood effect; the wood veneer layer of the composite structure may comprise a wood skin layer; the coating may comprise a paint layer and/or a gloss layer and/or a metallic layer and/or a metallic gloss layer and/or an ink layer and/or an ink transfer layer and/or a spray coating layer and/or a deposit layer and/or a PVD coating layer and/or a PVD spray coating layer.

The present invention relates to a component for a vehicle interior comprising a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the surface effect may be provided at the exterior surface of the cover and/or under the exterior surface of the cover; the visual effect may comprise a decorative effect for the cover; the base layer may comprise a wood material; the cover layer may comprise a coating configured to provide the exterior surface for the cover; the cover may comprise a coating comprising an applied material and/or a paint and/or an ink material and/or a deposited material and/or film; the base layer may comprise a light-transmissive material comprising a veneer material; the composite structure may comprise a substrate for the cover; the cover may comprise a light guide further comprising a light source configured to provide illumination at the cover of the composite structure; the cover may comprise a feature configured to provide the surface effect; the feature may comprise a layer and/or a layer of material and/or an applied material and/or a deposit and/or a deposit of material; the feature may be on the cove layer of the cover and/or on the exterior surface of the cover and/or within the cover and/or on the base layer of the cover and/or under the base layer of the cover; the feature may comprise a line on the composite structure and/or a decorative line on the composite structure; the decorative line may comprise a visual line for the cover and/or a trim line and/or a surface layer on the cover and/or an intermediate layer in the cover and/or an intermediate layer under the cover and/or a straight line and/or a set of lines for the cover and/or may be configured to be illuminated and/or a material and/or an surface layer material and/or an inlaid material and/or an intermediate layer material; the cover may comprise an intermediate layer configured to provide the surface effect; the visual effect may comprise the decorative effect and/or an illumination effect and/or a color effect and/or a dynamic decorative effect and/or a dynamic illumination effect and/or a texture effect and/or a color gloss effect and/or a light dark contrast effect and/or a gray scale contrast effect and/or a trim strip effect and/or a divider line effect and/or an inlaid appearance effect and/or a metal-like appearance effect; and/or a wood-like appearance effect; and/or a metallic appearance effect and/or an appearance of metal embedded in a cover material and/or an appearance of metal embedded in veneer and/or an appearance of metal embedded in wood veneer and/or a wood appearance from a wood material and/or a wood appearance from a non-wood material; and/or a metal appearance from a non-metal material and/or a natural/real wood inlaid metal appearance and/or a metallic decorative effect and/or a metallic decorative strip effect and/or a metallic decorative effect when the component may be unilluminated by the light source and/or an illuminated metallic decorative effect when the component may be illuminated by the light source and/or a wood grain effect combined with a metallic effect and/or a wood grain effect combined with a metallic light transmitting effect; the decorative effect may comprise a static effect and/or a dynamic effect and/or a texture effect and/or a color effect and/or a luster effect and/or a gloss effect and/or a matte effect and/or a grain effect and/or a wood grain effect and/or a metal effect and/or a metallic texture effect; the performance effect may comprise protection for the exterior surface and/or a tactile effect and/or a texture effect; the cover layer may be formed on the base layer and may comprise a film and/or a coating and/or an exterior layer and/or an applied layer and/or a formed layer and/or a molded layer and/or a coating layer; and/or a treatment layer and/or a veneer layer and/or a wood layer and/or a wood veneer layer and/or a light-transmissive veneer layer and/or a light-transmissive wood veneer layer and/or a coating layer comprising at least one of: (1) a paint layer; (2) a PVD layer; (3) an ink layer and/or a light guide material and/or a light-transmissive material and/or a mask and/or a shielding layer and/or a plurality of cover surface regions configured to provide a plurality of visual effects and/or a trim line and/or a decorative line and/or an illuminated line and/or a divider line and/or a line between adjacent cover surface regions and/or a trim line configured to provide a metallic visual effect; and/or a trim line configured to transmit light and/or trim and/or trim at an edge of the composite structure and/or trim configured to provide a metallic visual effect and/or trim configured to provide an illuminated visual effect; the cover may comprise a wood veneer layer and/or a light-transmissive wood veneer layer and/or a coating layer and/or an ink layer; the base layer may comprise a molded layer comprising a polymer material and/or a molded material and/or an injection molded material and/or a film and/or a polymer material and/or an elastomer and/or a thermo-resin elastomer and/or a resin layer and/or a substrate section and/or a structural section and/or a light-transmissive section and/or an opaque section and/or a non-light-transmissive section and/or an opaque section and a light-transmissive section and/or a resin substrate layer and/or an opaque resin substrate layer; the cover layer may be configured to provide a metallic decorative effect; the cover layer may comprise a coating comprising an ink layer and/or a coating layer comprising a treatment layer and/or a surface treatment layer and/or a protective layer and/or a light-transmissive coating layer and/or a light-transmissive protective layer and/or a paint layer and/or a layer configured to fill a texture of the wood veneer layer and/or a layer configured to fill a texture of the wood veneer layer and/or a layer configured to provide a flat exterior surface and/or a layer configured to protect the wood veneer layer and/or a layer configured to protect the ink layer and/or PVD layer; the cover layer may comprise an ink layer comprising a decorative gloss layer and/or a color gloss layer and/or a metal color gloss layer and/or a metallic gloss layer and/or a surface treatment layer and/or a coating and/or a metal-color coating and/or a metallic coating and/or a transfer layer and/or an ink transfer layer and/or a pad printing layer and/or an ink pad printing layer and/or a metallic ink layer and/or a printed metallic ink layer and/or a layer pad-printed on the wood veneer layer and/or a layer pad-printed on the coating layer; the cover may be configured to provide the visual effect when the component may be unilluminated by the light source and/or a light transmitting gloss effect when the component may be illuminated by the light source and/or a static visual effect when the component may be unilluminated by the light source and a dynamic visual effect when the component may be illuminated by the light source; the cover layer may comprise a deposited layer comprising a PVD layer comprising a vapor deposited layer and/or a vacuum evaporation coating and/or a PVD coating layer and/or a PVD spray coating layer and/or a PVD film layer and/or a PVD membrane and/or a PVD diaphragm and/or a layer between the coating layer and the wood veneer layer and/or a layer between the wood veneer layer and the base layer and/or a layer between the base layer and a light-transmissive section and/or a layer configured to provide a metallic decorative effect; the ink layer and/or the PVD layer may be on the coating layer and/or at the exterior surface and/or between the coating layer and the wood veneer layer and/or at the exterior surface of the cover and/or under the coating layer and/or under the wood veneer layer and/or under the base layer and/or under a light-transmissive section of the base layer and/or aligned with a light-transmitting region of the cover and/or aligned with a light-transmissive section of the base layer; the ink layer and/or the PVD layer may comprise a decorative feature and/or a decorative line and/or a trim feature and/or a trim line and/or may be at the trim; the composite structure may be configured to provide a wood grain effect and/or a gloss effect when illuminated by the light source and/or a metallic effect when illuminated by the light source and/or a metallic effect at the wood veneer layer; the substrate may comprise a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate; the component may comprise an instrument panel and/or a door panel and/or a console and/or a floor console and overhead console and/or an armrest and/or a trim insert and/or a trim panel and/or a trim component;

The present invention relates to a component for a vehicle interior comprising a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the surface effect may be provided at the exterior surface of the cover and/or under the exterior surface of the cover; the component may be produced by a method comprising the steps of: providing a base layer material for the base layer of the cover; providing cover layer material for the cover layer on the base layer; and providing the cover on the structural substrate; the step of providing the cover layer material on the base layer may comprise forming the cover layer material on the base layer; the step of providing the base layer material may comprise forming the base layer from the base layer material on the structural substrate; and the cover may be configured to provide the surface effect for the composite structure.

The present invention relates to a component for a vehicle interior comprising a composite structure comprising a substrate comprising a structural substrate and a cover; the cover may comprise a base layer and a cover layer; the base layer may comprise a wood veneer layer; the cover layer may comprise a coating; the composite structure may comprise a visual effect for the cover comprising a natural/real wood effect; the wood veneer layer of the composite structure may comprise a wood skin layer; the coating may comprise a paint layer and/or a gloss layer and/or a metallic layer and/or a metallic gloss layer and/or an ink layer and/or an ink transfer layer and/or a spray coating layer and/or a deposit layer and/or a PVD coating layer and/or a PVD spray coating layer.

The present invention relates to a component for a vehicle interior comprising a composite structure comprising a substrate and a cover; the cover may comprise a base layer and a cover layer; the cover layer may be configured to provide an exterior surface; the cover may be configured to provide a surface effect for the exterior surface; the surface effect may comprise a visual effect and/or a performance effect; the substrate may comprise a structural substrate.

The present invention relates to a component for a vehicle interior comprising a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the visual effect may comprise a decorative effect for the cover; the surface effect may be provided at the exterior surface of the cover and/or under the exterior surface of the cover; the surface effect may be provided within the cover; the surface effect may be provided within the cover layer of the cover and/or within the base layer of the cover; the surface effect may be provided at an intermediate layer of the cover; the visual effect may be provided at the exterior surface of the cover; the visual effect may be provided under the exterior surface of the cover; the visual effect may be provided within the cover; the visual effect may be provided within the cover layer of the cover; the visual effect may be provided within the base layer of the cover; the visual effect may be provided at an intermediate layer of the cover; the cover may comprise a coating; the coating may comprise an applied material; the coating may comprise a paint and/or an ink material and/or a deposited material and/or film; the coating may comprise a paint and an ink material and/or a deposited material; the cover layer may comprise the coating; the cover layer may be provided on the base layer; the cover layer may comprise the exterior surface for the cover; the cover layer may comprise a coating configured to provide the exterior surface for the cover; the base layer may comprise a veneer; the base layer may comprise a veneer layer; the base layer may comprise a veneer material; the base layer may comprise a wood material; the base layer may comprise a natural/real wood material; the base layer may comprise a wood veneer material; the base layer may comprise a light-transmissive material; the base layer may comprise a light-transmissive material comprising a veneer material; the base layer may comprise a light-transmissive material comprising a wood veneer material; the base layer may comprise a formed material; the cover layer may be formed on the base layer; the cover layer may be applied on the base layer; the base layer may comprise a substrate layer; the composite structure may comprise a substrate for the cover; the base layer may comprise a light-transmissive material within a veneer material; the base layer may comprise a light-transmissive material under a veneer material.

The present invention relates to a component for a vehicle interior comprising a composite structure comprising a cover; the cover may comprise a base layer and a cover layer; the cover layer may be configured to provide an exterior surface for the cover; the cover may comprise a profile; the profile of the cover may comprise a generally flat profile; the profile of the cover may comprise a generally flat surface; the profile of the cover may comprise a contoured profile; the profile of the cover may comprise a multi-faceted profile; the profile of the cover may comprise a multi-surface profile; the cover may comprise a light-transmissive section; the cover may comprise a light guide; the cover may comprise a light-transmissive material; the base layer of the cover may comprise a light-transmissive section; the base layer of the cover may comprise a light guide; the light guide may be within the base layer of the cover; the light guide may be under the base layer of the cover; the light guide may be under the cover layer of the cover; the cover may comprise an intermediate layer comprising a light-transmissive material; the cover may comprise an intermediate layer comprising a light guide; the component may further comprise a light source configured to provide illumination at the cover of the composite structure; the component may further comprise a light source configured to provide illumination for the cover of the composite structure; the component may further comprise a light source configured to provide illumination at the exterior surface of the cover of the composite structure; the cover may comprise a feature configured to provide the surface effect; the feature may comprise a layer; the feature may comprise a layer of material; the feature may comprise an applied material; the feature may comprise a deposit; the feature may comprise a deposit of material; the feature may be on the cover layer of the cover; the feature may be on the exterior surface of the cover; the feature may be within the cover; the feature may be on the base layer of the cover; the feature may be under the base layer of the cover; the feature may comprise a line on the composite structure; the feature may comprise a decorative line on the composite structure; the decorative line may comprise a visual line for the cover; the decorative line may comprise a trim line; the decorative line may comprise a surface layer on the cover; the decorative line may comprise an intermediate layer in the cover; the decorative line may comprise an intermediate layer under the cover; the decorative line may comprise a straight line; the decorative line may comprise a set of lines for the cover; the decorative line may be configured to be illuminated; the decorative line may comprise a material; the decorative line may comprise an surface layer material; the decorative line may comprise an inlaid material; the decorative line may comprise an intermediate layer material; the base layer and the cover layer may be configured to provide the surface effect; the cover layer may be configure to provide the surface effect; the base layer and the cover layer and a light guide may be configured to provide the surface effect; the cover may comprise an intermediate layer configured to provide the surface effect; the surface effect may comprise a decorative effect; the visual effect may comprise the decorative effect; the visual effect may comprise an illumination effect; the decorative effect may comprise a static effect; the decorative effect may comprise a dynamic effect; the decorative effect may comprise a color effect; the decorative effect may comprise a texture effect; the decorative effect may comprise a luster effect; the decorative effect may comprise a gloss effect; the decorative effect may comprise a matte effect; the decorative effect may comprise grain effect; the decorative effect may comprise wood grain effect; the decorative effect may comprise metal effect; the decorative effect may comprise metallic texture effect; the visual effect may comprise a color effect; the visual effect may comprise a dynamic decorative effect; the visual effect may comprise a dynamic illumination effect; the performance effect may comprise protection for the exterior surface; the performance effect may comprise protection for the exterior surface; the performance effect may comprise a tactile effect; the performance effect may comprise a texture effect; the tactile effect may comprise a texture effect; the visual effect may comprise a texture effect; the texture effect may comprise a grain effect and/or a metallic effect; the texture effect may comprise a grain effect and a metallic effect; the visual effect may comprise color and/or a texture effect and/or a grain effect; the visual effect may comprise a gloss effect and/or color gloss effect; the visual effect may comprise a light dark contrast effect; the visual effect may comprise a gray scale contrast effect; the visual effect may comprise a trim strip effect; the visual effect may comprise a divider line effect; the visual effect may comprise an inlaid appearance effect; the visual effect may comprise a metal-like appearance effect; the visual effect may comprise a wood-like appearance effect; the visual effect may comprise a metallic appearance effect; the visual effect may comprise an appearance of metal embedded in a cover material; the visual effect may comprise an appearance of metal embedded in veneer; the visual effect may comprise an appearance of metal embedded in wood veneer; the visual effect may comprise a wood appearance from a wood material; the visual effect may comprise a wood appearance from a non-wood material; the visual effect may comprise a metal appearance from a non-metal material; the visual effect may comprise a natural/real wood inlaid metal appearance; the visual effect may comprise a metallic decorative effect; the visual effect may comprise a metallic decorative strip effect; the visual effect may comprise a metallic decorative effect when the component may be unilluminated by the light source; the visual effect may comprise an illuminated metallic decorative effect when the component may be illuminated by the light source; the visual effect may comprise a wood grain effect combined with a metallic effect; the visual effect may comprise a wood grain effect combined with a metallic light transmitting effect; the cover may comprise an intermediate layer configured to provide the surface effect; the intermediate layer may comprise an opaque layer; the cover may comprise an opaque layer; the cover may comprise an opaque material; the opaque material may comprise a mask layer; the intermediate layer may comprise a mask layer; the surface effect may be provided by the cover layer; the performance effect may be provided by the cover layer and/or the base layer; the cover layer may comprise a film and/or a coating and/or an exterior layer; the cover layer may be formed on the base layer; the cover layer may comprise an applied layer; the cover layer may comprise a formed layer; the cover layer may comprise a molded layer; the cover layer may comprise a coating layer; the cover layer may comprise a treatment layer; the cover layer may comprise a veneer layer; the cover layer may comprise a wood layer; the cover layer may comprise a wood veneer layer; the cover layer may comprise a light-transmissive veneer layer; the cover layer may comprise a light-transmissive wood veneer layer; the cover layer may comprise a coating layer.

The present invention relates to a component for a vehicle interior comprising a composite structure comprising a cover; the cover may comprise a base layer and a cover layer; the cover layer may be configured to provide an exterior surface for the cover; the cover layer may comprise a coating layer comprising a paint layer; the cover layer may comprise a coating layer comprising a PVD layer; the cover layer may comprise a deposit layer comprising an ink layer; the cover layer may comprise a light guide material; the cover layer may comprise a light-transmissive material; the cover layer may comprise a mask; the cover layer may comprise a shielding layer; the cover may comprise a wood veneer layer and a coating layer; the cover may comprise a wood veneer layer and a PVD layer; the cover may comprise a wood veneer layer and an ink layer; the cover may comprise a coating layer and an ink layer; the cover may comprise a coating layer and a PVD layer; the cover may comprise a base layer and a wood veneer layer and a coating layer and an ink layer; the cover may comprise a base layer and a light-transmissive wood veneer layer and a coating layer and an ink layer; the cover may comprise a base layer and a wood veneer layer and a coating layer and a PVD layer; the cover layer may comprise a plurality of cover surface regions configured to provide a plurality of visual effects; the cover layer may comprise a trim line; the cover layer may comprise a decorative line; the cover layer may comprise an illuminated line; the cover layer may comprise a divider line; the cover layer may comprise a line between adjacent cover surface regions; the cover layer may comprise a trim line configured to provide a metallic visual effect; the cover layer may comprise a trim line configured to transmit light; the cover layer may comprise trim; the cover layer may comprise trim at an edge of the composite structure; the cover layer may comprise trim configured to provide a metallic visual effect; the cover layer may comprise trim configured to provide an illuminated visual effect; the base layer may comprise a molded layer comprising a polymer material and/or a molded material and/or an injection molded material and/or a film and/or a polymer material and/or an elastomer and/or a thermo-resin elastomer; the base layer may comprise a resin layer; the base layer may comprise a substrate section; the base layer may comprise a structural section; the base layer may comprise a light-transmissive section; the base layer may comprise a light transmitting section; the base layer may comprise a light-transmissive material; the base layer may comprise an opaque section; the opaque section may comprise a non-light-transmissive section; the base layer may comprise a non-light-transmissive section; the base layer may comprise an opaque section and a light-transmissive section; the base layer may comprise a resin substrate layer; the base layer may comprise an opaque resin substrate layer; the base layer may comprise a non-light-transmissive resin substrate layer; the base layer may comprise a resin substrate layer; the light-transmissive material of the base layer may comprise a light transmitting resin layer; the base layer may comprise a resin substrate layer and a light-transmissive material; the base layer may comprise a light-transmissive resin layer within a resin substrate layer; the base layer may comprise a light-transmissive material at the cover layer; the base layer may comprise a light-transmissive material at an ink layer and/or the PVD layer; the base layer may be configured to provide structural support for the cover layer; the base layer may comprise a masking section and/or shielding section.

The present invention relates to a component for a vehicle interior comprising a composite structure comprising a cover; the cover may comprise a base layer and a cover layer; the cover layer may be configured to provide an exterior surface for the cover; the base layer may comprise a veneer layer; the cover layer may comprise a veneer layer; the base layer may comprise a wood layer; the veneer layer may comprise a wood veneer layer; the wood layer may comprise a wood veneer layer; the wood layer may comprise a natural/real wood layer; the wood layer may comprise a wood layer; the wood layer may comprise a natural/real wood veneer; the wood layer may comprise a wood skin layer; the wood layer may comprise an ordinary veneer layer; the wood layer may comprise an natural/real wood layer; the cover layer may comprise an opaque veneer layer; the cover layer may comprise an opaque wood veneer layer; the cover layer may comprise a light transmitting veneer layer; the cover layer may comprise a light transmitting wood veneer layer; the cover layer may comprise a translucent veneer layer; the cover layer may comprise a translucent wood veneer layer; the cover layer may be configured to provide a natural/real grain effect and/or wood grain effect and/or natural/real wood appearance texture; the cover layer may be non-planar; the cover layer may be formed into a profile comprising a shape; the cover layer may be hot pressed into a profile comprising a shape; the cover layer may comprise a light-transmitting region and/or non-light-transmitting region; the wood veneer layer may comprise a light-transmitting region and/or non-light-transmitting region; the cover layer may comprise an opening and/or a cutout; the cover layer may comprise a hollow region and/or hollow region; the cover layer may comprise a laser-carved region and/or laser-engraved region; the cover layer may comprise a hollow region in a light-transmitting region; the cover layer may comprise a non-hollow region adjacent to a hollow region in a light-transmitting region; the cover layer may comprise a shielding section and/or shielding layer; the cover layer may comprise a opaque material and/or non-woven shielding layer and/or ink shielding layer; the light-transmissive wood veneer layer may be configured to transmit light from a substrate side of the cover toward the exterior surface; the light-transmissive wood veneer layer may be configured to transmit light through the ink layer; the light-transmissive wood veneer layer may be configured to transmit light through the PVD layer; the cover layer may be configured to provide a metallic decorative effect without a separate carrier film; the cover layer may be configured to provide a metallic decorative effect without a separate metallic diaphragm; the cover layer may be configured to provide a metallic decorative effect without a metal insert; the cover layer may be translucent and/or light transmitting; the cover layer may be configured to provide the visual effect when the component may be unilluminated by the light source; the cover layer may be configured to provide a light transmitting gloss effect when the component may be illuminated by the light source; the cover layer may be configured to provide a static visual effect when the component may be unilluminated by the light source and a dynamic visual effect when the component may be illuminated by the light source; the cover layer may be configured to provide a static visual effect when the component may be unilluminated by the light source and a dynamic visual effect when the component may be illuminated by the light source; the cover layer may be configured to shield an internal structure when the component may be unilluminated by the light source.

The present invention relates to a component for a vehicle interior comprising a composite structure comprising a cover; the cover may comprise a base layer and a cover layer; the cover layer may be configured to provide an exterior surface for the cover; the cover layer may comprise a coating; the coating of the cover layer may comprise a coating layer; the coating layer may comprise a treatment layer and/or a surface treatment layer; the coating layer may comprise a protective layer and/or a light-transmissive coating layer and/or a light-transmissive protective layer; the coating layer may comprise a paint layer; the coating layer may be configured to fill a texture of the wood veneer layer; the coating layer may be configured to provide a flat exterior surface; the coating layer may be configured to protect the wood veneer layer; the coating layer may be configured to protect the ink layer and/or PVD layer; the cover layer may comprise an ink layer; the ink layer may comprise a decorative gloss layer; the ink layer may comprise a color gloss layer; the ink layer may comprise a metal color gloss layer; the ink layer may comprise a metallic gloss layer; the ink layer may comprise a surface treatment layer; the ink layer may comprise a coating and/or a metal-color coating and/or metallic coating; the ink layer may comprise a transfer layer; the ink layer may comprise an ink transfer layer; the ink layer may comprise a pad printing layer; the ink layer may comprise an ink pad printing layer; the ink layer may comprise a metallic ink layer; the ink layer may comprise a printed metallic ink layer; the ink layer may be pad-printed on the wood veneer layer; the ink layer may be pad-printed on the coating layer; the cover layer may comprise a deposited layer; the cover layer may comprise a PVD layer; the deposited layer may comprise a PVD layer; the PVD layer may comprise a vapor deposited layer and/or a vacuum evaporation coating; the PVD layer may comprise a PVD coating layer; the PVD layer may comprise a PVD spray coating layer; the PVD layer may comprise a PVD film layer and/or a PVD membrane and/or a PVD diaphragm; the PVD layer may be between the coating layer and the wood veneer layer; the PVD layer may be between the wood veneer layer and the base layer; the PVD layer may be between the base layer and a light-transmissive section; the PVD layer may be configured to provide a metallic decorative effect; the ink layer and/or the PVD layer may be in the cover; the ink layer and/or the PVD layer may be on the coating layer; the ink layer and/or the PVD layer may be at the exterior surface; the ink layer and/or the PVD layer may be between the coating layer and the wood veneer layer; the ink layer and/or the PVD layer may be at the exterior surface of the cover; the ink layer and/or the PVD layer may be under the coating layer; the ink layer and/or the PVD layer may be under the wood veneer layer; the ink layer and/or the PVD layer may be under the base layer; the ink layer and/or the PVD layer may be under a light-transmissive section of the base layer; the ink layer and/or the PVD layer may be aligned with a light-transmitting region of the cover; the ink layer and/or the PVD layer may be aligned with a light-transmissive section of the base layer; the ink layer and/or the PVD layer may comprise a decorative feature; the ink layer and/or the PVD layer may comprise a decorative line; the ink layer and/or the PVD layer may comprise a trim feature; the ink layer and/or the PVD layer may comprise a trim line; the ink layer and/or the PVD layer may be at the trim.

The present invention relates to a component for a vehicle interior comprising a composite structure comprising a cover; the cover may comprise a base layer and a cover layer; the cover layer may be configured to provide an exterior surface for the cover; the cover may comprise a light guide material; the base layer of the cover may comprise a light guide material; the light guide material of the base layer may be configured to direct light to the cover layer; the light guide material may comprise a light-transmissive section of the base layer; the light guide material may comprise a light-transmissive material; the light guide material may be configured to direct light to the trim line of the cover; the light guide material may be configured to direct light to the ink layer of the cover; the light guide material may be configured to direct light to the PVD layer of the cover; the light guide material may be adjacent to a mask layer of the cover; the composite structure may comprise a light-transmitting region; the composite structure may comprise a non-light-transmitting region; the non-light-transmitting region may comprise an opaque region; the composite structure may comprise an opaque region; the composite structure may comprise a light-transmitting region and a non-light-transmitting region; the light source may be configured to transmit light through the base layer; the light source may be configured to transmit light through the light guide material; the light source may be configured to transmit light through the wood veneer layer; the light source may be configured to transmit light through the coating layer; the light source may be configured to transmit light through the ink layer and/or the PVD layer; the composite structure may be configured to provide a wood grain effect and a gloss effect when illuminated by the light source; the composite structure may be configured to provide a wood grain effect and a metallic effect when illuminated by the light source; the composite structure may be configured to provide a metallic effect at the wood veneer layer; the composite structure may be configured to block light in a mask region; the composite structure may be configured to transmit light in a decorative region; the composite structure may be configured to provide an ambient lighting effect; the performance effect may comprise stain resistance and/or fluid repellence and/or hardness and/or softness and/or scratch resistance and/or tactile performance and/or antifouling; the performance effect may comprise light blocking and/or light transmission and/or shielding and/or layer protection and/or scratch protection and/or bonding and/or support and/or structural strength; the surface effect may comprise adhesion evaluation and/or wear resistance and/or stain resistance evaluation and/or water droplet angle and/or feel evaluation and/or texture and/or static friction coefficient and/or dynamic friction coefficient; the substrate may comprise a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate; the component may comprise an instrument panel and/or a door panel and/or a console and/or a floor console and overhead console and/or an armrest and/or a trim insert and/or a trim panel and/or a trim component.

The present invention relates to a component for a vehicle interior comprising a composite structure comprising a cover; the cover may comprise a base layer and a cover layer; the cover layer may be configured to provide an exterior surface for the cover; the component may be produced by a method comprising the steps of: providing a base layer material for the base layer of the cover; providing cover layer material for the cover layer on the base layer; and providing the cover on a structural substrate; the step of providing the cover layer material on the base layer may comprise forming the cover layer material on the base layer; the step of providing the base layer material may comprise forming the base layer from the base layer material on the structural substrate; and the cover may be configured to provide the surface effect for the composite structure; the method may comprise providing the wood veneer layer and providing a coating layer; the method may comprise providing the coating layer as an ink layer; the method may comprise injection molding a generally opaque material to provide the a substrate and molding a light-transmissive material to provide a light-transmissive section for the cover; the method may comprise applying an ink layer for the cover by ink transfer and/or metallic ink transfer and/or pad printing and/or metallic ink pad printing; the method may comprise applying a PVD layer for the cover by PVD processing and/or the PVD coating and/or the PVD spraying and/or vacuum evaporation coating and/or providing a PVD film and/or providing a PVD diaphragm.

The present invention relates to a component for a vehicle interior comprising a composite structure comprising a substrate comprising a structural substrate and a cover; the cover may comprise a base layer and a cover layer; the base layer may comprise a wood veneer layer; the cover layer may comprise a coating; the composite structure may comprise a visual effect for the cover comprising a natural/real wood effect; the wood veneer layer of the composite structure may comprise a wood skin layer; the coating may comprise a paint layer and/or a gloss layer and/or a metallic layer and/or a metallic gloss layer and/or an ink layer and/or an ink transfer layer and/or a spray coating layer and/or a deposit layer and/or a PVD coating layer and/or a PVD spray coating layer; the composite structure may comprise natural/real wood trim; the cover may comprise the base layer and the wood veneer layer and the paint layer and the metallic gloss layer; the cover may comprise the base layer and the wood skin layer and the paint layer and the metal gloss layer; the cover may comprise a bottom-to-top structure comprising the base layer and the wood veneer layer and the paint layer; the cover may comprise a bottom-to-top structure comprising the base layer and the wood skin layer and the paint layer; the metallic gloss layer may be on the paint layer; the metal gloss layer may be on the paint layer; the base layer may comprise an opaque resin substrate layer; the base layer may comprise a light-transmissive material; the base layer may comprise an opaque resin substrate layer and a light-transmissive material; the metallic gloss layer may be on the base layer when the base layer may comprise the opaque resin substrate layer; the metallic gloss layer may be on or below the base layer when the base layer may comprise the light-transmissive material; the metallic gloss layer may be at least partially in a region corresponding to the light-transmissive material; the wood veneer layer may comprise a shielding layer; the wood skin layer may comprise a shielding layer; the base layer may comprise a resin substrate layer and a light-transmissive material and the metallic gloss layer may be on or below the light-transmissive material; the light-transmissive material may be within the resin substrate layer in a light-transmitting region; the wood veneer layer may comprise natural/real wood veneer; the wood veneer layer may comprise a light-transmitting wood skin layer; the wood skin layer may comprise an opaque wood veneer and the metal gloss layer may be on the wood veneer; the wood skin layer may comprise an wood veneer having a hollow structure in a light-transmitting region; produced by a method comprising the steps of: providing a base layer on a back side of the wood veneer layer; providing a paint layer on an upper surface of the wood veneer layer; and providing a metallic gloss layer in an ink transfer manner or the PVD spray manner; the method may comprise performing a first insert injection molding on the back side of the wood veneer layer to provide a resin substrate layer; the method may comprise performing a second insert injection molding on the back side of the wood veneer layer to provide a light-transmissive material; the method may comprise performing the first insert injection molding with non-light-transmissive resin; the method may comprise performing the second insert injection molding with light-transmissive resin; the method may comprise hot pressing the wood veneer layer into a desired shape before providing the base layer; the method may comprise laser carving the wood veneer layer; the method may comprise CNC milling a part/component edge after providing the base layer to remove a process edge; the method may comprise grinding an upper surface of the wood veneer layer before providing the paint layer; the method may comprise cutting the wood veneer layer; the method may comprise shading the wood veneer layer.

The present invention relates to a component for an interior of a vehicle comprising a composite structure configured to provide appearance of natural/real wooden trim comprising a cover comprising a base layer and a cover layer and a paint layer; the composite structure may comprise a metal gloss layer comprising an ink transfer layer and/or a PVD spray coating layer; the ink transfer layer may be on the paint layer; the cover layer may comprise a wood skin layer; the base layer may comprise an opaque resin substrate layer and/or a resin light-transmissive layer; the base layer may comprise an opaque resin substrate layer and a metallic luster layer may be provided on the base layer; the base layer may comprise a resin light-transmissive layer; the metallic luster layer may be at the base layer; the metallic luster layer may be in a region corresponding to the resin light-transmissive layer; the wood skin layer may comprise a shielding layer comprising a mask material; the base layer may comprise a resin substrate layer and a resin light-transmissive layer; the metallic luster layer may be at the resin light-transmissive layer; the resin light-transmissive layer may be within the resin substrate layer in the light-transmitting region; the cover layer may comprise a wood veneer and/or a light-transmitting wood veneer; the cover layer may comprise the wood veneer comprising an opaque wood veneer; the metal gloss layer may be on the wood veneer; the wood veneer may comprise an open section to provide a light-transmitting region; the method may comprise the step of providing a base layer for the wood veneer; providing a paint layer for a surface of the wood veneer; and providing a metallic gloss layer as an ink-transfer material and/or a PVD-spray material; the method may comprise: performing an injection molding for the wood veneer to provide a resin substrate layer and performing an injection molding for the wood veneer to provide a resin light-transmissive layer; injection molding may comprise insert injection molding of a non-light-transmissive resin; the method may comprise hot-pressing the wood veneer into a shape before providing the base layer; the method may comprise laser carving the wood veneer; the method may comprise CNC milling a part/component edge after providing the base layer to remove the process edge; the method may comprise grinding an upper surface of the wood veneer before providing the paint layer; the method may comprise cutting the wood veneer and/or shading the wood veneer.

The present invention relates to a component for a vehicle interior configured to provide an armrest comprising a cover; a pad and a base. The pad may be configured to provide a surface effect. The cover, the pad and the base may comprise a polymer material. The polymer material may be configured for recyclability and to reduce the carbon dioxide footprint. The polymer material may be selected from a group of polymer materials and may comprise a mono-material or a single material group. The surface effect may comprise at least one of (a) softness, (b) deep softness, (c) compression, (d) elastic deformation. The pad may comprise a structure; the structure may comprise a set of ribs. The set of ribs may be arranged in (a) parallel lines, (b) wavy lines, (c) angled lines, (d) perpendicular lines, (e) circles, (f) honeycomb shape. The set of ribs in angled lines may be configured to bend under pressure and return when pressure is released. The ribs may be inclined by 45 degrees to prevent breakage under pressure. The set of ribs may comprise joints; the joints may be configured as a second set of ribs. The second set of ribs may comprise curved ribs. Each joint may comprise a connection of three ribs. The pad may be injection molded and may be demoldable. The angled lines of the ribs may be configured to run in the same direction to enable a demolding. The pad may comprise a thickness greater than 10 mm.

The component may comprise at least one of (a) a door panel; (b) a floor console; (c) a seat component.

### FIGURES

FIG. 1A is a schematic perspective view of a vehicle according to an exemplary embodiment.

FIG. 1B is schematic perspective view of a vehicle interior according to an exemplary embodiment.

FIG. 2 is a schematic front perspective view of a vehicle interior according to an exemplary embodiment.

FIGS. 2A through 2C are schematic front perspective views of a vehicle interior comprising a component with a composite structure according to an exemplary embodiment.

FIGS. 3A and 3B are schematic perspective views of a vehicle interior component comprising a composite structure according to an exemplary embodiment.

FIGS. 3C and 3D are schematic perspective detail views of a vehicle interior component comprising a composite structure according to an exemplary embodiment.

FIG. 4 is a schematic perspective view of a vehicle interior component comprising a composite structure according to an exemplary embodiment.

FIGS. 4A and 4B are schematic perspective views of a vehicle interior component comprising a composite structure according to an exemplary embodiment.

FIG. 5 is e schematic side elevation view of a vehicle interior component comprising a composite structure according to an exemplary embodiment.

FIG. 6 is e schematic side elevation view of a vehicle interior component comprising a composite structure according to an exemplary embodiment.

FIG. 7 is e schematic side elevation view of a vehicle interior component comprising a composite structure according to an exemplary embodiment.

FIG. 8 is e schematic side elevation view of a vehicle interior component comprising a composite structure according to an exemplary embodiment.

FIG. 9 is e schematic side elevation view of a vehicle interior component comprising a composite structure according to an exemplary embodiment.

FIG. 10 is a schematic side elevation view of a vehicle interior component comprising a composite structure according to an exemplary embodiment.

FIG. 11 is a schematic side elevation detail view of a vehicle interior component comprising a composite structure according to an exemplary embodiment.

FIG. 12 is a schematic side elevation detail view of a vehicle interior component comprising a composite structure according to an exemplary embodiment.

FIG. 13 is a schematic side elevation detail view of a vehicle interior component comprising a composite structure according to an exemplary embodiment.

FIG. 14 is a schematic side elevation view of a vehicle interior component comprising a composite structure according to an exemplary embodiment.

FIG. 15 is a schematic perspective view of a vehicle interior component comprising a composite structure according to an exemplary embodiment.

FIG. 16 is a schematic perspective view of a vehicle interior component comprising a composite structure according to an exemplary embodiment.

FIGS. 17A and 17B are schematic perspective views of a vehicle interior component comprising a composite structure according to an exemplary embodiment.

FIG. 18 is a schematic perspective view of a vehicle interior component comprising a composite structure according to an exemplary embodiment.

FIG. 19 is a schematic perspective view of a vehicle interior component comprising a composite structure according to an exemplary embodiment.

FIG. 20 is a schematic perspective view of a vehicle interior component comprising a composite structure according to an exemplary embodiment.

FIG. 21 is a schematic perspective view of a vehicle interior component comprising a composite structure according to an exemplary embodiment.

FIG. 22A is a schematic diagram of a vehicle interior component comprising a composite structure according to an exemplary embodiment.

FIGS. 22B and 22C are schematic perspective views of a vehicle interior component comprising a composite structure according to an exemplary embodiment.

FIGS. 23A and 23B are schematic perspective views of a vehicle interior component comprising a composite structure according to an exemplary embodiment.

FIG. 23C is a schematic side elevation view of a vehicle interior component comprising a composite structure according to an exemplary embodiment.

FIGS. 24A and 24B are schematic perspective views of a vehicle interior component comprising a composite structure according to an exemplary embodiment.

FIG. 24C is a schematic side elevation view of a vehicle interior component comprising a composite structure according to an exemplary embodiment.

FIGS. 25A and 25B are schematic perspective views of a vehicle interior component comprising a composite structure according to an exemplary embodiment.

FIG. 25C is a schematic side elevation view of a vehicle interior component comprising a composite structure according to an exemplary embodiment.

FIGS. 26A and 26B are schematic perspective views of a vehicle interior component comprising a composite structure according to an exemplary embodiment.

FIG. 26C is a schematic side elevation view of a vehicle interior component comprising a composite structure according to an exemplary embodiment.

FIGS. 27A and 27B are schematic perspective views of a vehicle interior component comprising a composite structure according to an exemplary embodiment.

FIG. 27C is a schematic side elevation view of a vehicle interior component comprising a composite structure according to an exemplary embodiment.

FIGS. 28A and 28B are schematic perspective views of a vehicle interior component comprising a composite structure according to an exemplary embodiment.

FIG. 28C is a schematic side elevation view of a vehicle interior component comprising a composite structure according to an exemplary embodiment.

FIGS. 29A and 29B are schematic perspective views of a vehicle interior component comprising a composite structure according to an exemplary embodiment.

FIG. 29C is a schematic side elevation view of a vehicle interior component comprising a composite structure according to an exemplary embodiment.

FIG. 30A is a schematic perspective view of a vehicle interior component comprising a composite structure according to an exemplary embodiment.

FIGS. 30B and 30C are schematic perspective views of a method of producing a vehicle interior component comprising a composite structure according to an exemplary embodiment.

FIG. 31 is a schematic perspective view of a vehicle interior component comprising a composite structure according to an exemplary embodiment.

FIG. 32A is a schematic perspective view of a vehicle interior component comprising a composite structure according to an exemplary embodiment.

FIGS. 32B and 32C are schematic perspective views of a method of producing a vehicle interior component comprising a composite structure according to an exemplary embodiment.

FIG. 33 is a schematic perspective view of a vehicle interior component comprising a composite structure according to an exemplary embodiment.

FIG. 34A is a schematic perspective view of a vehicle interior component comprising a composite structure according to an exemplary embodiment.

FIGS. 34B and 34C are schematic perspective exploded views of a vehicle interior component comprising a composite structure according to an exemplary embodiment.

FIGS. 34D and 34E are schematic perspective views of a vehicle interior component comprising a composite structure according to an exemplary embodiment.

FIGS. 35A through 35C are schematic side elevation views of a method of producing a vehicle interior component comprising a composite structure according to an exemplary embodiment.

FIG. 36A is a schematic perspective view of a vehicle interior component comprising a composite structure according to an exemplary embodiment.

FIG. 36B is a schematic perspective exploded view of a vehicle interior component comprising a composite structure according to an exemplary embodiment.

FIGS. 36C and 36D are schematic side elevation views of a vehicle interior component comprising a composite structure according to an exemplary embodiment.

FIG. 37A is a schematic side elevation view of a vehicle interior component comprising a composite structure according to an exemplary embodiment.

FIG. 37B is a schematic side elevation exploded view of a vehicle interior component comprising a composite structure according to an exemplary embodiment.

FIG. 37C is a schematic perspective view of a vehicle interior component comprising a composite structure according to an exemplary embodiment.

FIG. 37D is a schematic perspective exploded view of a vehicle interior component comprising a composite structure according to an exemplary embodiment.

FIG. 38A is a schematic side elevation view of a vehicle interior component comprising a composite structure according to an exemplary embodiment.

FIG. 38B is a schematic side elevation exploded view of a vehicle interior component comprising a composite structure according to an exemplary embodiment.

FIG. 38C is a schematic perspective view of a vehicle interior component comprising a composite structure according to an exemplary embodiment.

FIG. 38D is a schematic perspective exploded view of a vehicle interior component comprising a composite structure according to an exemplary embodiment.

FIG. 39A is a schematic perspective view of a vehicle interior component comprising a composite structure according to an exemplary embodiment.

FIG. 39B is a schematic side elevation view of a vehicle interior component comprising a composite structure according to an exemplary embodiment.

FIG. 40A is a schematic perspective view of a vehicle interior component comprising a composite structure according to an exemplary embodiment.

FIG. 40B is a schematic side elevation view of a vehicle interior component comprising a composite structure according to an exemplary embodiment.

FIG. 41A is a schematic perspective view of a vehicle interior component comprising a composite structure according to an exemplary embodiment.

FIG. 41B is a schematic side elevation view of a vehicle interior component comprising a composite structure according to an exemplary embodiment.

FIG. 41C is a schematic perspective view of a vehicle interior component comprising a composite structure according to an exemplary embodiment.

FIG. 42A is a schematic perspective view of a vehicle interior component comprising a composite structure according to an exemplary embodiment.

FIG. 42B is a schematic side elevation view of a vehicle interior component comprising a composite structure according to an exemplary embodiment.

FIGS. 43A and 43B are schematic perspective views of a vehicle interior component comprising a composite structure according to an exemplary embodiment.

FIGS. 44A through 44D are schematic perspective views of a vehicle interior component comprising a composite structure according to an exemplary embodiment.

FIGS. 44E and 44F are schematic side elevation views of a vehicle interior component comprising a composite structure according to an exemplary embodiment.

FIG. 45 is schematic flow diagram of a method of producing a vehicle interior component comprising a composite structure according to an exemplary embodiment.

FIG. 46 is schematic flow diagram of a method of producing a vehicle interior component comprising a composite structure according to an exemplary embodiment.

FIG. 47 is schematic flow diagram of a method of producing a vehicle interior component comprising a composite structure according to an exemplary embodiment.

FIG. 48 is schematic flow diagram of a method of producing a vehicle interior component comprising a composite structure according to an exemplary embodiment.

### DESCRIPTION

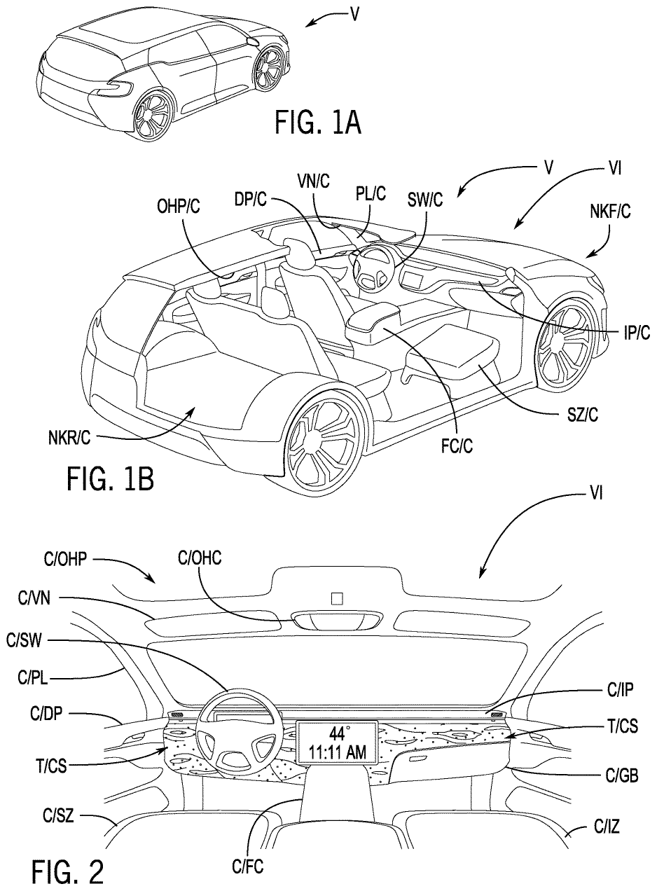

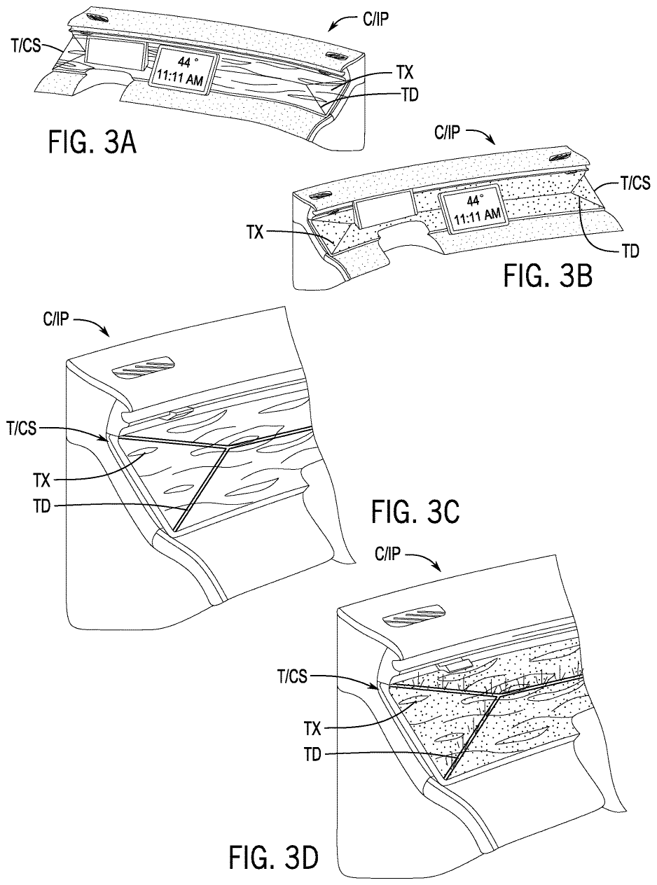

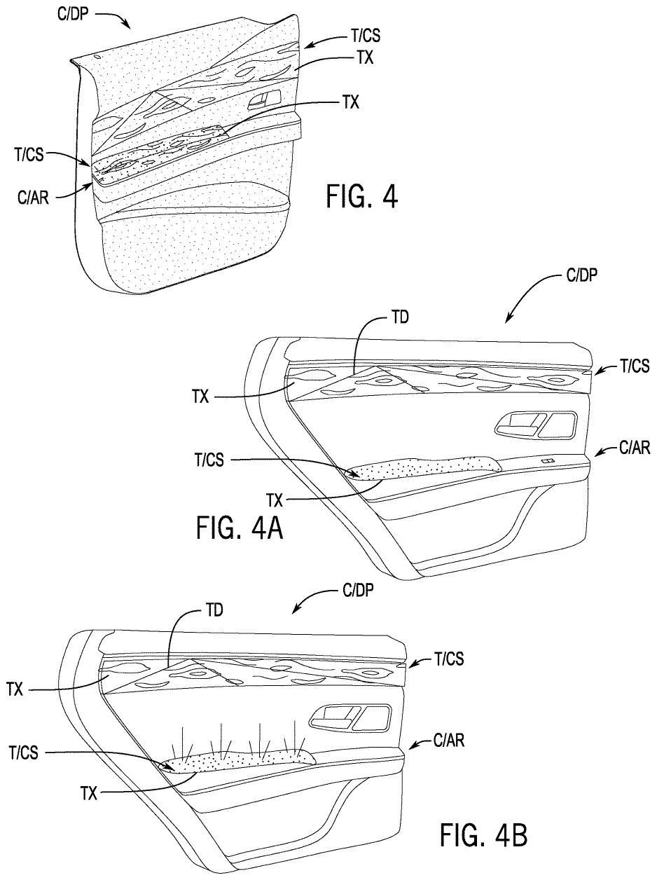

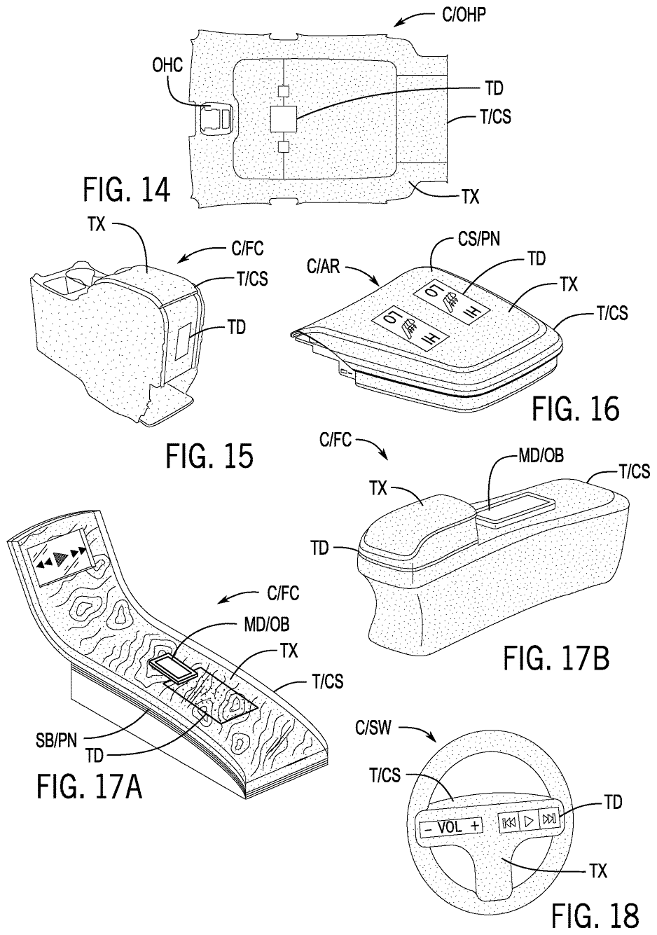

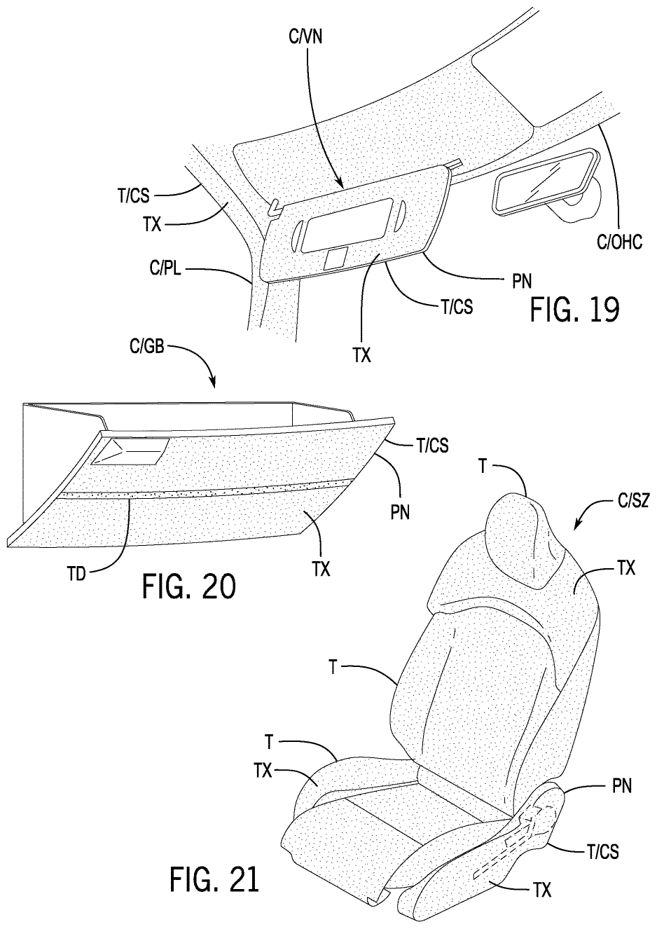

Referring to . . . Referring to FIGS. 1A-1B, a vehicle V with a vehicle interior VI comprising components C is shown according to an exemplary embodiment. As indicated schematically according to an exemplary embodiment in FIGS. 1B, 2, 2A-2C, 3A-3D, 4, 4A-4B, 14, 15, 16, 17A-17B, 18, 19, 20 and 21, component C for the vehicle interior VI may comprise an instrument panel IP, overhead console OHC, floor console FC, door panel DP, pillar PL, visor/vanity VN, receptacle/storage GB, seat assembly SZ, panel PN, steering wheel SW, armrest AR; the component may comprise any form of component, trim component, trim insert, trim panel, decorative panel, decorative trim, etc.

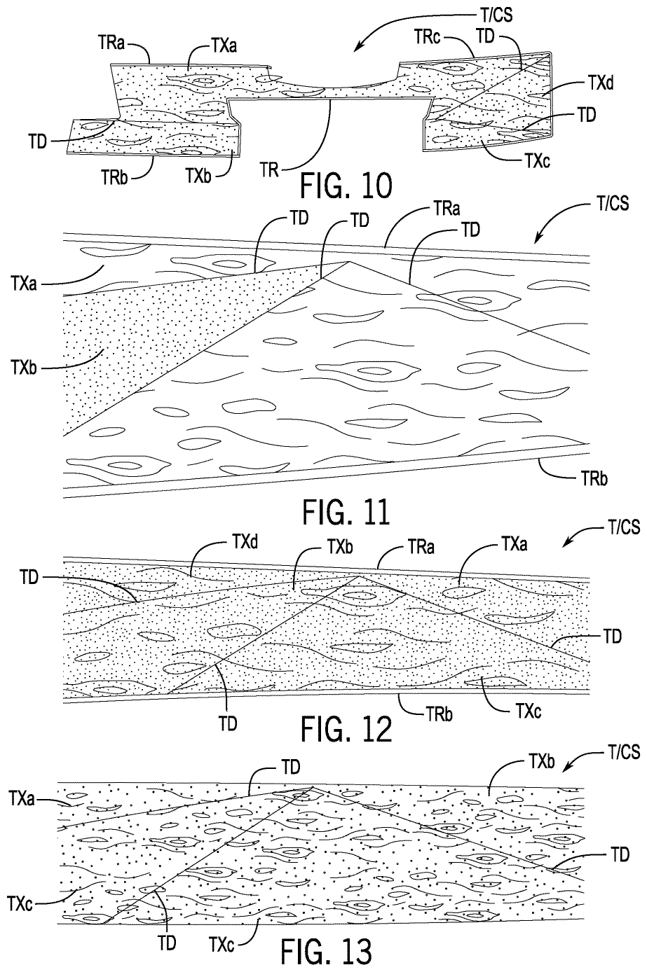

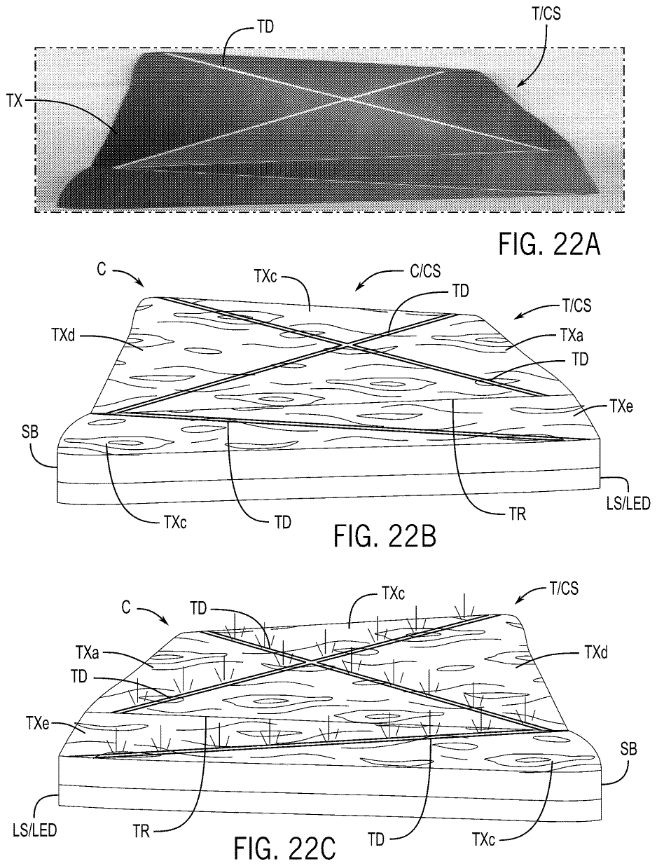

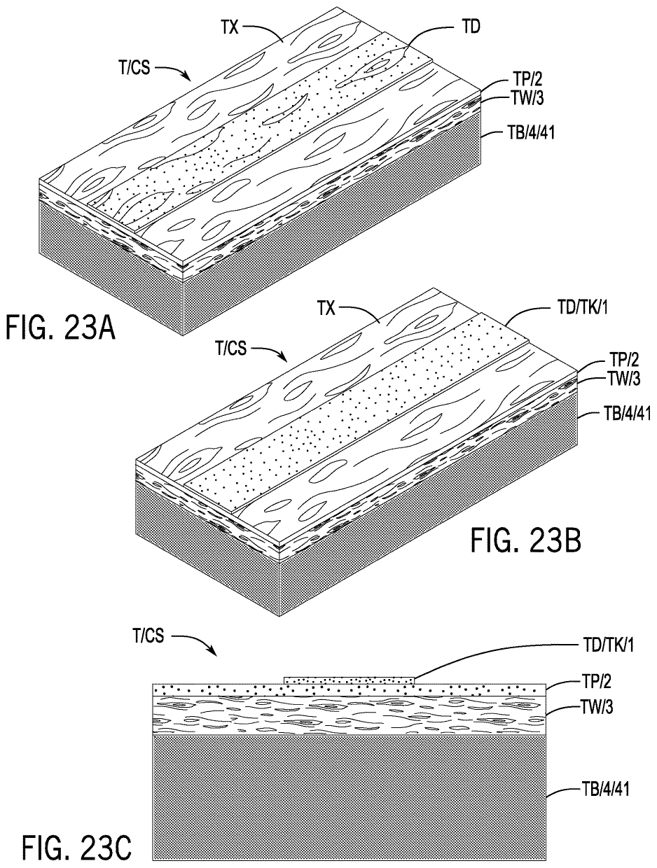

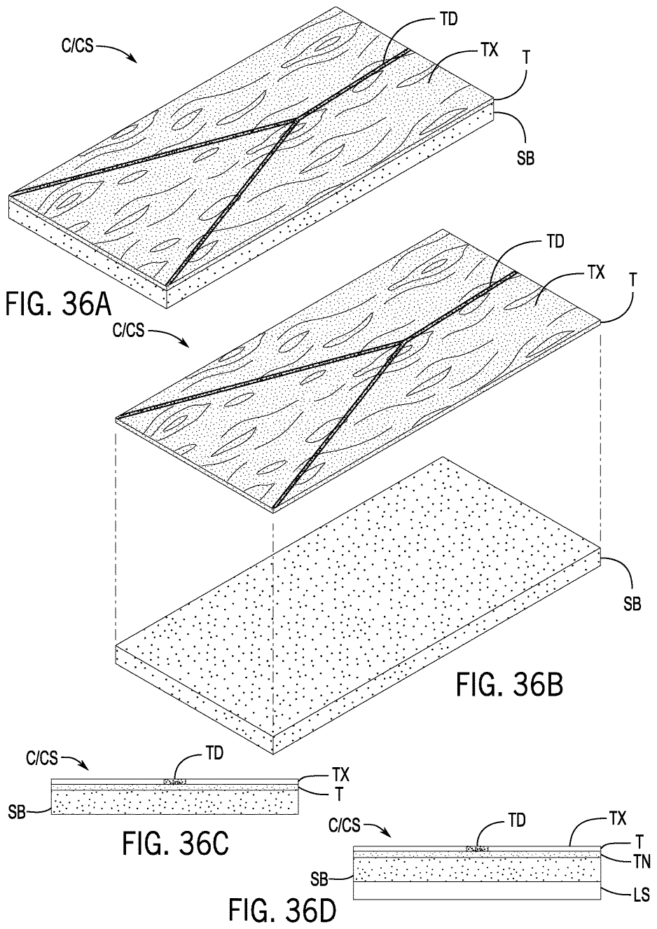

As indicated schematically in FIGS. 1B, 2, 2A-2C, 3A-3D, 4, 4A-4B, 5, 6, 7, 8, 9, 10, 11, 12 and 13, component C may comprise a composite structure CS comprising a cover T; cover T may comprise a base layer TB and a cover layer TX. As indicated schematically in FIGS. 22A-22B, 31, 33, 34E. 37A-37D, 38A-38D, 39A-39B, 40A-40B, 41A-41C and 42A-42B, composite structure CS may comprise a substrate SB configured to provide a structural substrate for component C. See also FIGS. 1B, 2, 2A-2C, 3A-3D, 4, 4A-4B, 14, 15, 16, 17A-17B, 18, 19, 20, 21 and 43A-43B, 44A-44D. As indicated schematically in FIGS. 36D, 41A-41C and 42A-42B, cover T of composite structure CS may comprise an intermediate layer TN configured to provide a functional layer and/or or decorative layer/effect for component C. See also FIGS. 23A-23C, 24A-24C, 25A-25C, 26A-26C, 27A-27C, 28A-28C and 29A-29C.

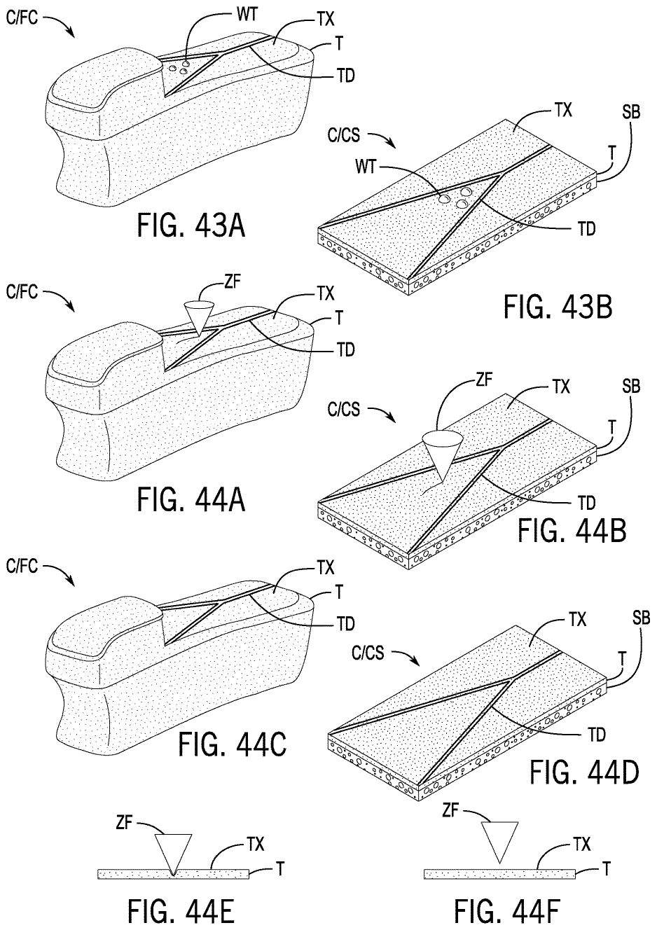

As indicated schematically in FIGS. 1B, 2, 2A-2C, 3A-3D, 4, 4A-4B, 5, 6, 7, 8, 9, 10, 11, 12 and 13, component C may comprise a composite structure CS comprising a cover T; cover T may comprise a base layer TB and a cover layer TX; cover layer TX may be configured to provide an exterior surface for cover T; cover T may be configured to provide a surface effect for the exterior surface; the surface effect may comprise a visual effect such as a decorative effect (e.g. color/colors, gloss, luster, texture, grain, wood grain, metal appearance, illumination, etc.) and/or a performance effect (e.g. durability, texture, softness/hardness, liquid/stain repellence/resistance, scratch resistance, etc.); the surface effect may be provided at the exterior surface of cover T and/or under the exterior surface of cover T. See also FIGS. 43A-43B and 44A-44F (exterior surface of cover indicating performance effect such as liquid/stain repellence/resistance, scratch resistance, etc.). As indicated schematically in FIG. 1B, cover T of composite structure CS of component C may be comprise a set of sections of cover layer TX and a trim strip/line arrangement TD and trim/edge TR; exterior surface at cover layer TX may be configured to provide the visual effect such as a decorative effect (e.g. color, texture, grain, wood grain, illumination, etc.); trim strip/line TD may be configured to provide the visual effect such as a decorative effect (e.g. color, metal effect, gloss effect, illumination, inlaid/inlay effect, surface effect, etc.); exterior surface of cover layer with strip/line may provide a combined surface effect comprising the effect of visual effect and decorative effect of materials of cover T of composite structure CS. See also FIGS. 22A-22C, 36A-36-D, 37A-37D, 38A-38D, 39A-39B, 40A-40B, 41A-41C and 42A-42B.

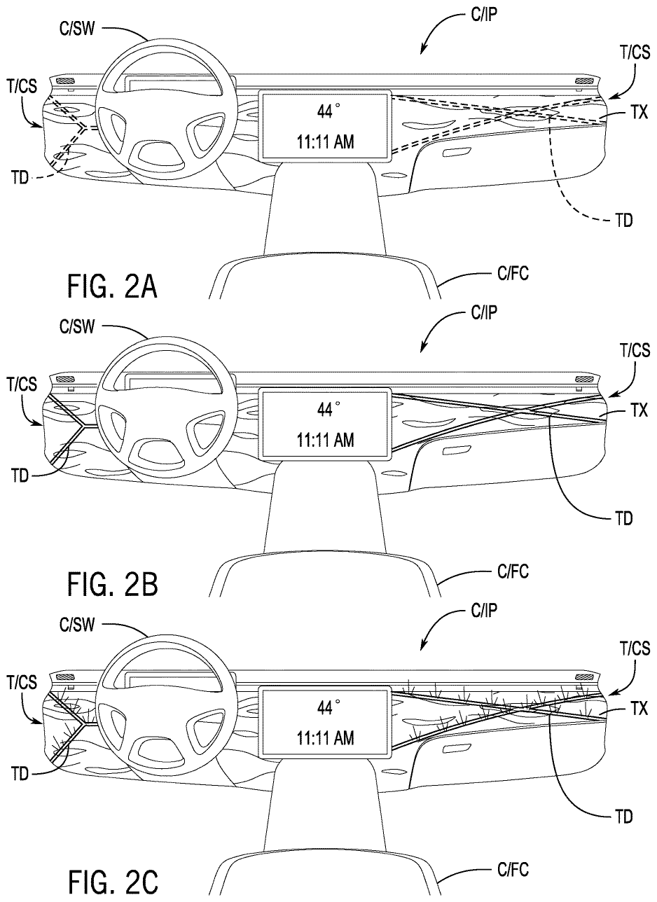

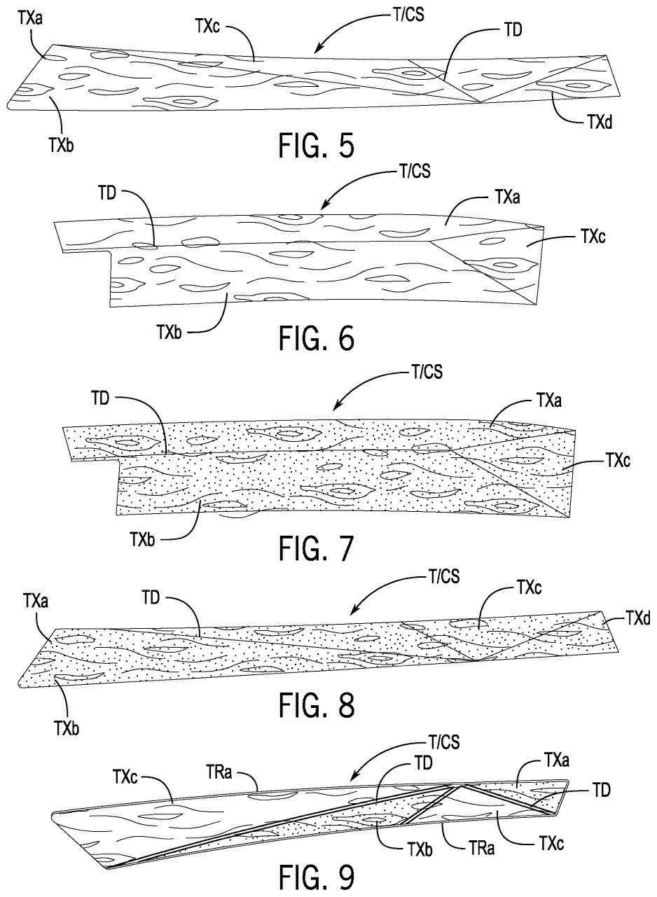

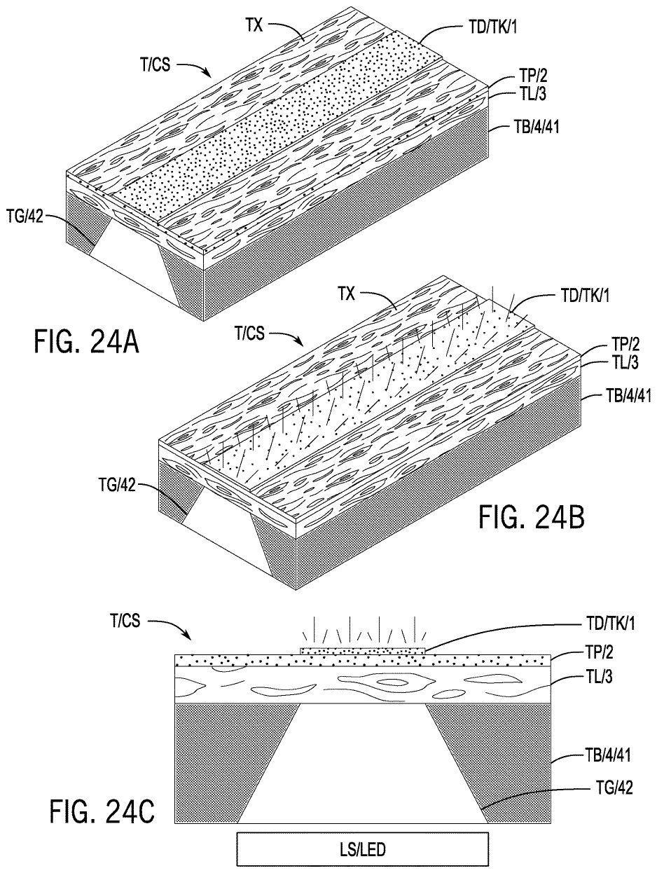

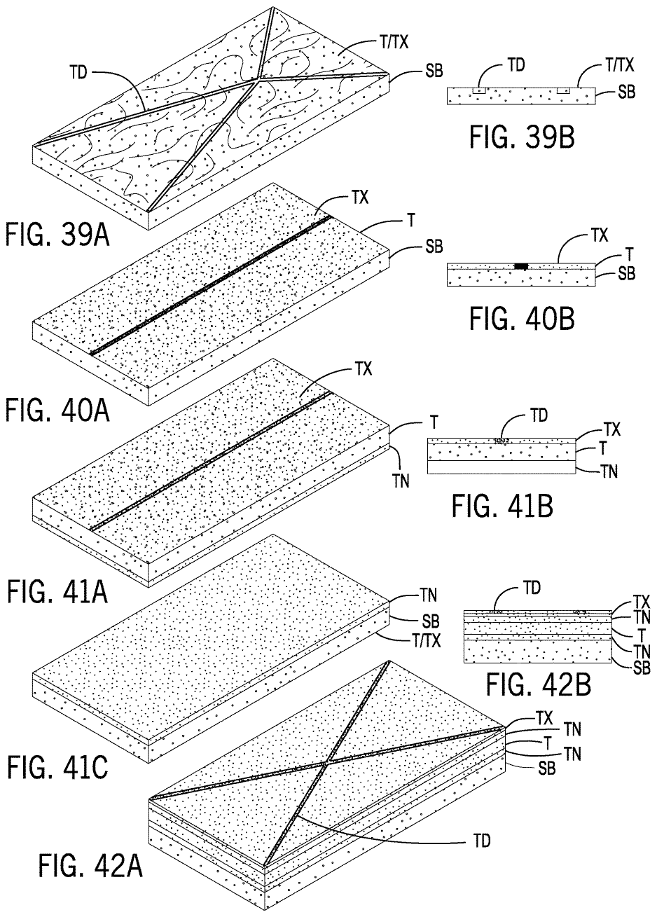

As indicated schematically in FIGS. 2A-2C, 3A-3D, 4A-4B, 22A-22C, the trim strip/line arrangement TD of cover T of composite structure CS may be configured to be illuminated by a light source LS (such as a LED lamp, LED panel, light panel, light surface, etc.); trim line TD may be configured to provide an ambient effect (e.g. unilluminated) and an illuminated effect (e.g. illuminated by light source); the illumination effect may be configured to enhance a color effect and/or a metallic effect of the trim strip/line TD at the exterior surface of the cover and cover layer TX. See also FIGS. 24A-24C, 25A-25C, 26A-26C and 29A-29C. As indicated schematically in FIGS. 23A-23C, 24A-24C, 25A-25C, 26A-26C, 27A-27C, 28A-28C and 29A-29C, the visual effect and/or decorative effect of trim strip/line TD for cover layer TX of cover T of composite structure CS may be provided at the exterior surface of cover T, under the exterior surface of cover T, within cover T, within cover layer TX and/or within base layer TB; trim strip/line TD may comprise a feature configured to provide the surface effect and/or to provide display indicia, etc. See also FIGS. 2A-2C, 3A-3D, 4, 4A-4B, 15, 16, 19 and 22A-22C. As indicated schematically in FIGS. 5, 6, 7, 8, 9, 10, 11, 12 and 13, the cover layer TX of cover T of composite structure CS may comprise a set of sections/facets; the cover T of composite structure CS may comprise a trim strip/line arrangement comprising a set of trim strips/lines TD. See also FIGS. 2A-2C, 3A-3D, 4A-4B, 37A-37D, 38A-38D, 39A-39B, 42A-42B, 43A-43B and 44A-44D.

As indicated schematically in FIGS. 5, 6, 7, 8, 9, 10, 11, 12, 13 and 22A-22C, the cover T of composite structure CS may be configured with a contoured shape and/or a faceted shape; cover T may comprises a trim edge TR and trim strip/line TD for cover layer TX; cover layer TX may comprise a multi-region and/or multi-surface appearance; trim edge TR may comprise a border/edge for cover T; trim strip/line TD may comprise a divider line for facets or sections/regions of exterior surface of cover layer TX of cover T. See also FIG. 2. 3A-3B, 4, 14, 15, 16, 17A-17B, 18, 19, 20 and 21.

As indicated schematically in FIGS. 22A-22C, the cover T of composite structure CS may comprise a cover layer TX and trim strip/line TD configured to provide an exterior surface comprising any of a variety of surface effects including visual effect and decorative effect such as natural/real wood grain effect and/or metal/metallic effect and/or color/multi-color effect and/or dark/light contrast effect and/or ambient effect and/or illuminated effect and/or multi-facet effect and/or multi-surface effect, etc.; the surface effect of cover T may be provided from/on external surface and/or at external surface and/or under external surface and/or within cover, etc. See also FIGS. 23A-23C, 24A-24C, 25A-25C, 26A-26C, 27A-27C, 28A-28C and 29A-29C.

As indicated schematically in FIGS. 23A-23C, composite structure CS may comprise cover T with base layer TB with material shown as wood/veneer material TW and cover layer TX with material shown as coating/paint layer TP and with surface material shown as deposited/ink layer TK to provide trim strip/line TD; as indicated schematically, cover T with cover layer TX and trim strip/line TD is configured to provide surface effect as a visual effect comprising an ambient effect and a reflected effect.

As indicated schematically in FIGS. 24A-24C, composite structure CS may comprise cover T with base layer TB with light-transmissive layer shown as wood/veneer material TL and light-guide TG (coupled to a light source LS/LED) and cover layer TX with material shown as coating/paint layer TP and with surface material shown as deposited/ink layer TK to provide trim strip/line TD; as indicated schematically, cover T with cover layer TX and trim strip/line TD is configured to provide surface effect as a visual effect comprising an ambient effect and an illuminated effect.

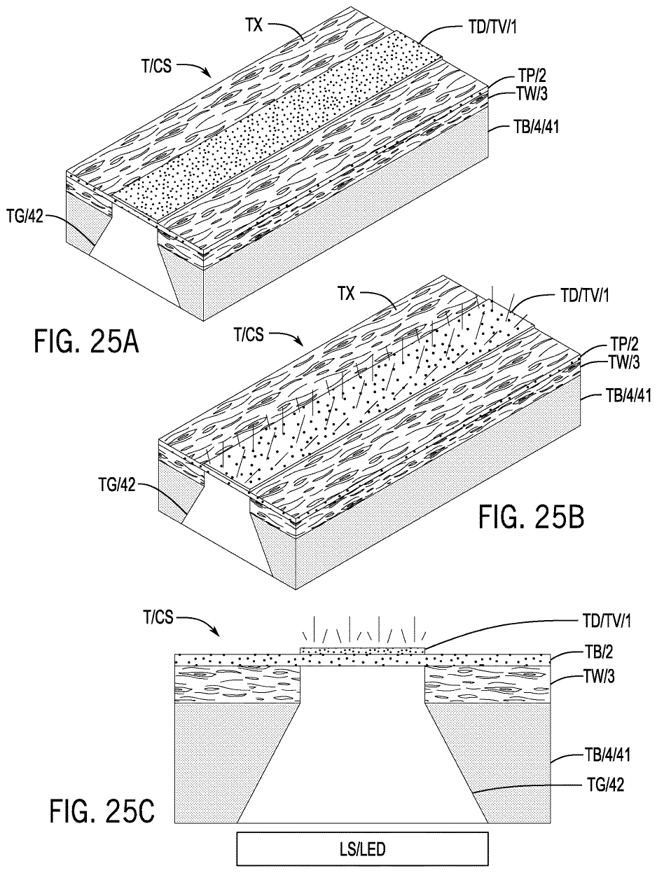

As indicated schematically in FIGS. 25A-25C, composite structure CS may comprise cover T with base layer TB with material shown as wood/veneer material TW and light-guide TG (coupled to a light source LS/LED) and cover layer TX with material shown as coating/paint layer TP and with surface material shown as deposited/ink layer TK to provide trim strip/line TD; as indicated schematically, cover T with cover layer TX and trim strip/line TD is configured to provide surface effect as a visual effect comprising an ambient effect and an illuminated effect.

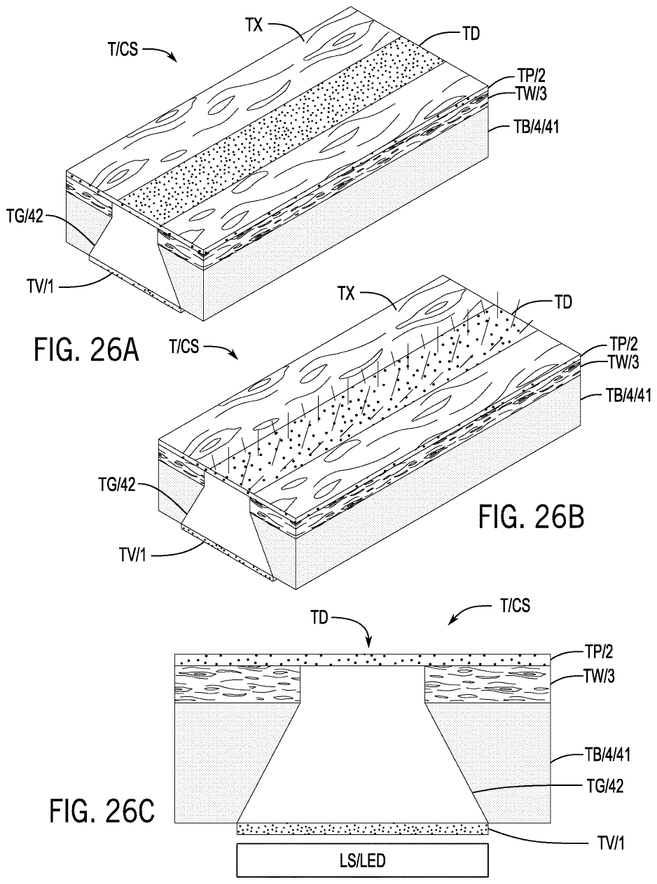

As indicated schematically in FIGS. 26A-26C, composite structure CS may comprise cover T with base layer TB with material shown as wood/veneer material TW and light-guide TG (coupled to a light source LS/LED) and material shown as deposit/layer TV to provide trim strip/line TD as a visual effect at cover layer TX with material shown as coating/paint layer TP; as indicated schematically, cover T with cover layer TX and trim strip/line TD is configured to provide surface effect as a visual effect comprising an ambient effect and an illuminated effect.

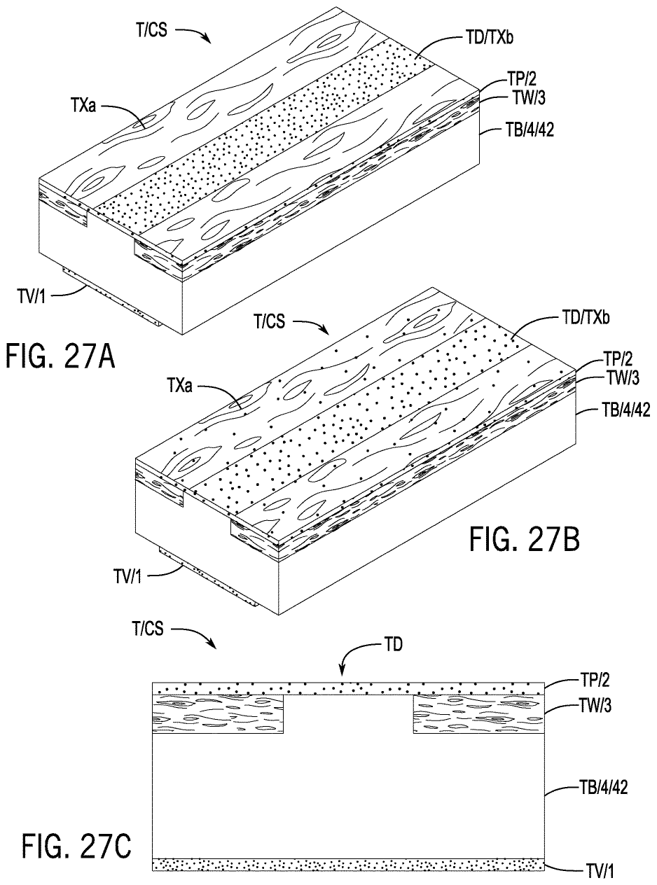

As indicated schematically in FIGS. 27A-27C, composite structure CS may comprise cover T with base layer TB with material shown as wood/veneer material TW and material shown as deposit/layer TV to provide trim strip/line TD as a visual effect at cover layer TX with material shown as coating/paint layer TP; as indicated schematically, cover T with cover layer TX and trim strip/line TD is configured to provide surface effect as a visual effect comprising an ambient effect and a reflected effect.

As indicated schematically in FIGS. 28A-28C, composite structure CS may comprise cover T with base layer TB with material shown as wood/veneer material TW and material shown as deposit/layer TV to provide trim strip/line TD as a visual effect at cover layer TX with material shown as coating/paint layer TP; as indicated schematically, cover T with cover layer TX and trim strip/line TD is configured to provide surface effect as a visual effect comprising an ambient effect and a reflected effect.

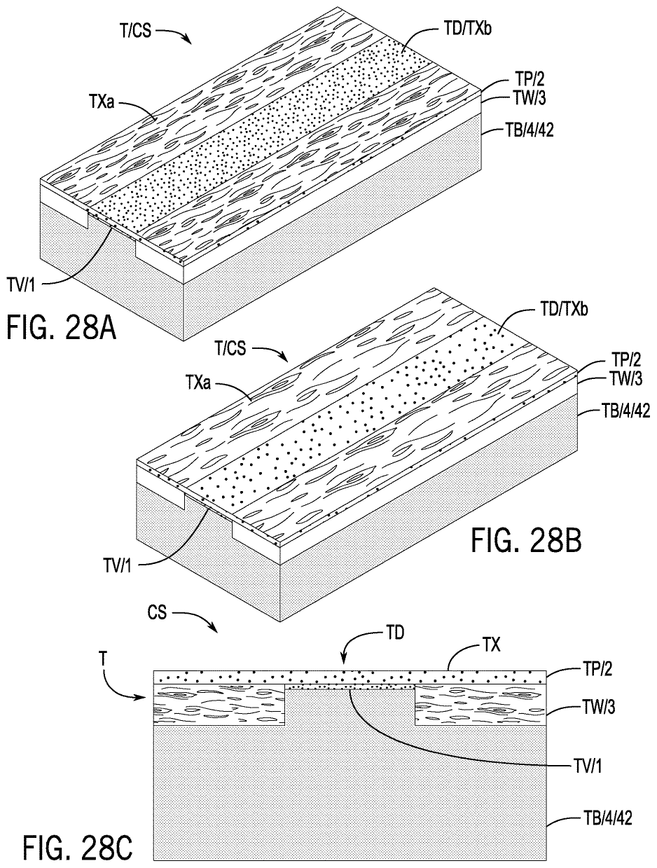

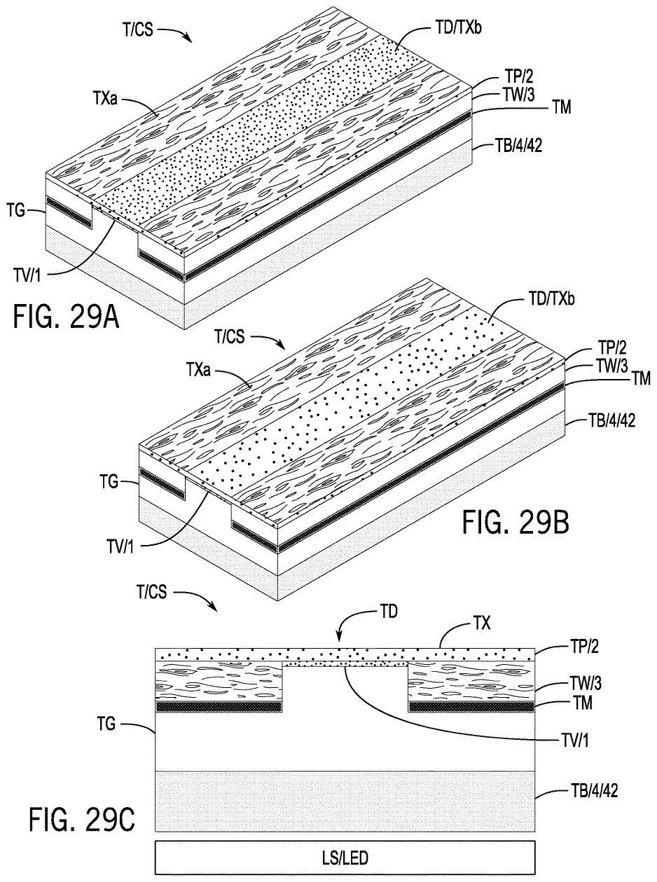

As indicated schematically in FIGS. 29A-29C, composite structure CS may comprise cover T with base layer TB with material shown as wood/veneer material TW and light-guide TG (coupled to a light source LS/LED) and material shown as mask/shield layer TM and material shown as deposit/layer TV to provide trim strip/line TD as a visual effect at cover layer TX with material shown as coating/paint layer TP; as indicated schematically, cover T with cover layer TX and trim strip/line TD is configured to provide surface effect as a visual effect comprising an ambient effect and an illuminated effect.

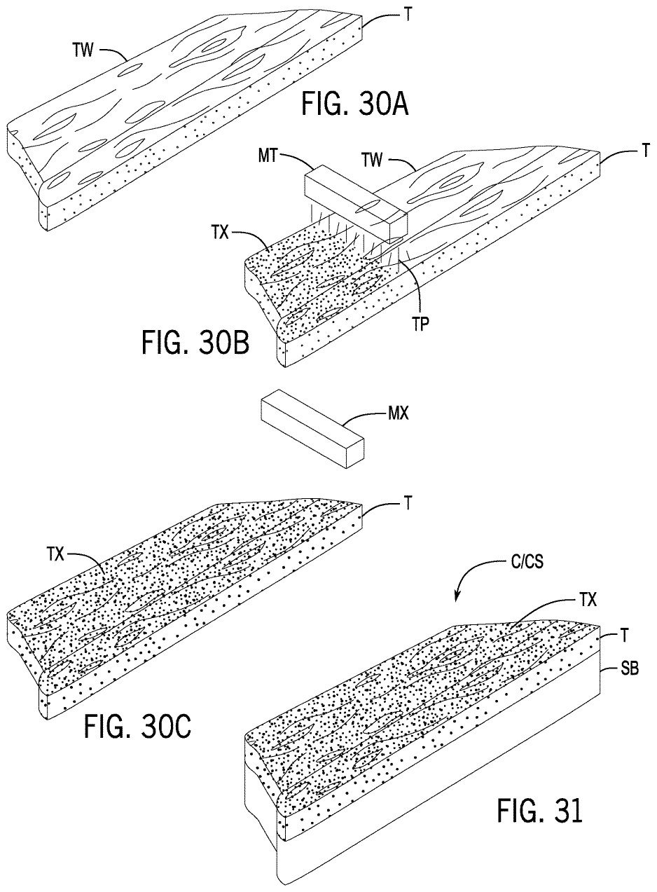

As indicated schematically in FIGS. 30A-30C, 31, 32A-32C, 33, 34A-34E, 35A-35C, 36A-36D, 37A-37D, 38A-38D, 39A-39B, 40A-40B, 41A-41C and 42A-42B, composite structure CS with cover T may comprise a cover layer TX and/or trim strip/line TD formed/applied (e.g. as applied material TP and/or ink NK) or assembled as a material/layer; the material may comprise a coating, paint, ink, fill, film, layer, etc. See also FIGS. 22A-22C, 23A-23C, 24A-24C, 25A-25C, 26A-26C, 27A-27C, 28A-28C and 29A-29C. As indicated schematically, the coating/paint layer of cover layer may comprise a material such as a coating/deposit on/above the base layer of cover; as indicated schematically, the trim strip/line for cover layer may comprise a material such as a coating/deposit for the cover; material/deposit may comprise an ink layer, ink material, deposited material, ink transfer layer, pad printing layer, ink pad printing layer, metallic ink layer, printed metallic ink layer, metal-color coating, luster layer, gloss layer, metallic gloss layer.

As indicated schematically in FIGS. 30A-30C, cover T may be formed/treated and/or coated to provide cover layer TX; tool such as a spray head/apparatus MX may apply coating TP to cover T to provide cover layer TX. See also FIG. 31.

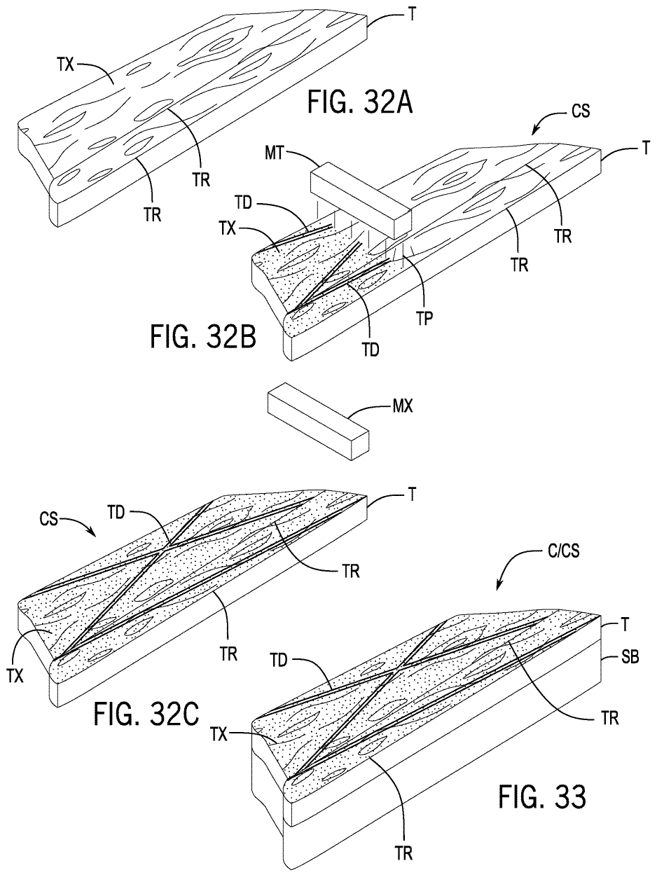

As indicated schematically in FIGS. 32A-32C, cover T may be formed/treated and/or coated to provide trim strip/line TD of cover layer TX; tool such as a spray head/apparatus MX may apply coating TP to cover T to provide trim strip/line TD for cover layer TX. See also FIG. 33.

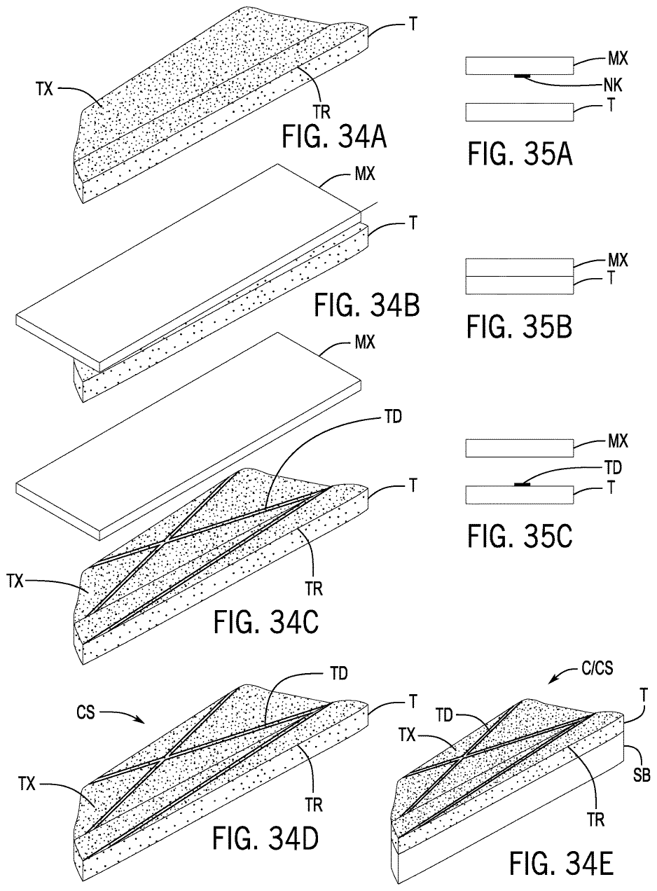

As indicated schematically in FIGS. 34A-34E and 35A-35C, cover T may be formed/treated and/or coated to provide trim strip/line TD of cover layer TX; tool such as an ink stamp/apparatus MX may apply ink/coating NK to cover T to provide trim strip/line TD for cover layer TX. See also FIG. 33.

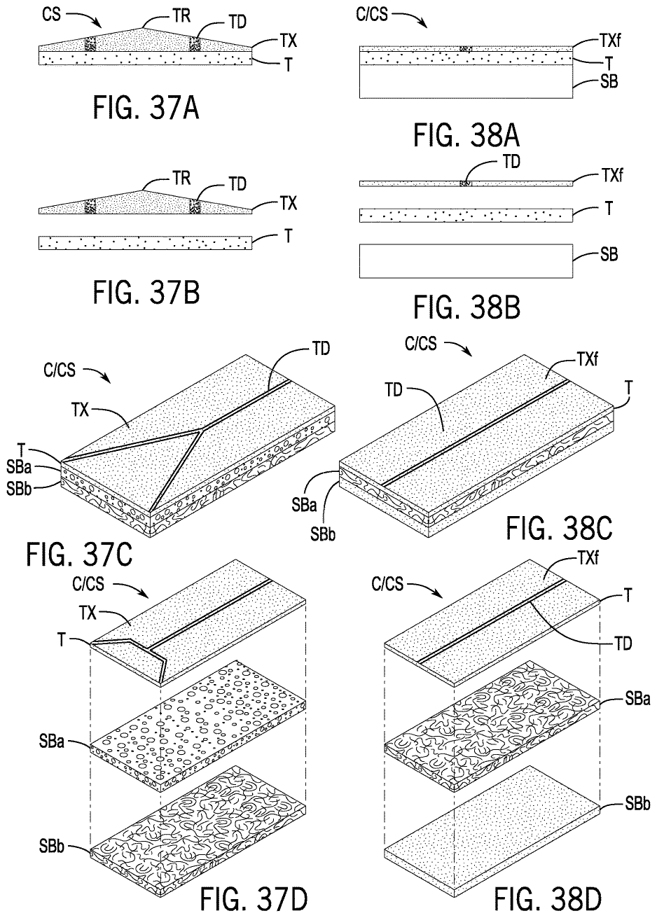

As indicated schematically in FIGS. 36A-36D, composite structure CS may comprise component C with cover T, cover layer TX, trim line TD and substrate/base SB. As indicated schematically in FIG. 36A, cover layer TX may be provided at an exterior side of cover T; trim line TD may be provided at cover layer TX; cover T may be provided on substrate/base SB; trim line TD may comprise dark dots and/or a dark line. As indicated schematically in FIG. 36B, cover T may be assembled with substrate/base SB. As indicated schematically in FIG. 36C, cover T may comprise cover layer TX on cover T and substrate/base SB. As indicated schematically in FIG. 36D, intermediate layer TN may be provided between cover T and substrate/base SB; light source LS may be provided at a substrate side of substrate/base SB and/or cover T. See also FIGS. 37A-37D.

As indicated schematically in FIGS. 43A-43B and 44A-44F, cover T if composite structure CS of cover T may comprise a base layer TB and cover layer TX configured to provide a performance effect such as stain/liquid repellence, scratch resistance, wear resistance, hardness, softness, tactile performance, deformation resistance, durability, layer protection, surface protection, etc. (performance effect indicated by use of force-applying tool/object ZF).

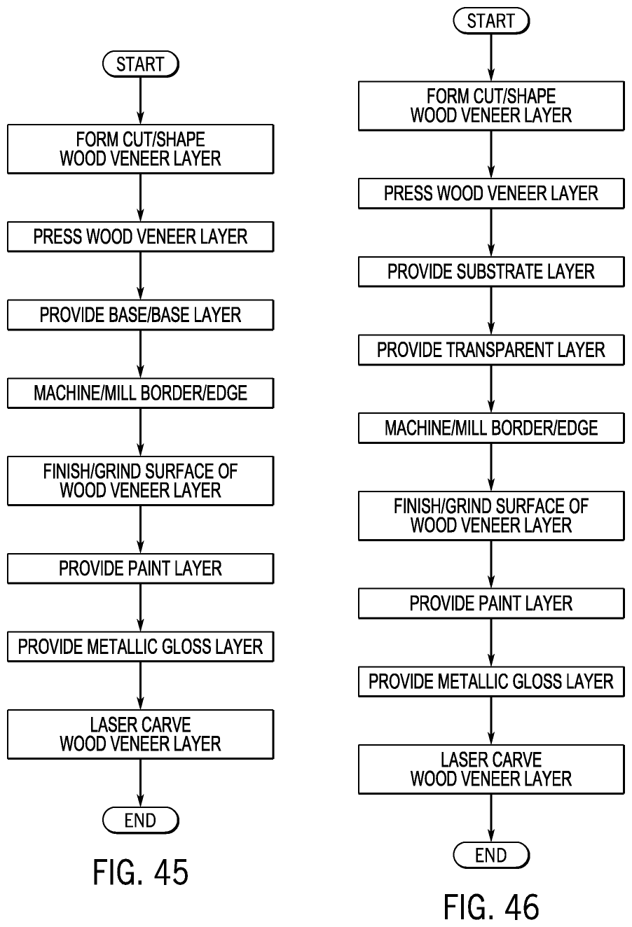

As indicated schematically in FIG. 45, a method of producing component C with composite structure CS comprising cover T may comprise step of forming/cutting/shaping wood veneer layer TW (step S0); step of pressing wood veneer layer TW (step S1); step of providing base/base layer TB (step S2); step of machining/milling border/edge (step S3); step of finishing/grinding surface of wood veneer layer TW (step S4); step of providing paint layer such as coating TP (step S5); step of providing metallic gloss layer such as deposit TK and/or coating TV (step S6); and step of laser carving wood veneer layer TW (step S7).

As indicated schematically in FIG. 46, a method of producing component C with composite structure CS comprising cover T may may comprise step of forming/cutting/shaping wood veneer layer TW (step S0); step of pressing wood veneer layer TW (step S1); step of providing substrate layer such as base layer TB and/or resin substrate layer (step S2A); step of providing transparent layer such as light guide/light-transmissive material TG and/or light-transmissive resin layer (step S2B); step of machining/milling border/edge (step S3); step of finishing/grinding surface of wood veneer layer TW (step S4); step of providing paint layer such as coating TP (step S5); step of providing metallic gloss layer such as deposit TK and/or coating TV (step S6); and step of laser carving wood veneer layer TW (step S7).

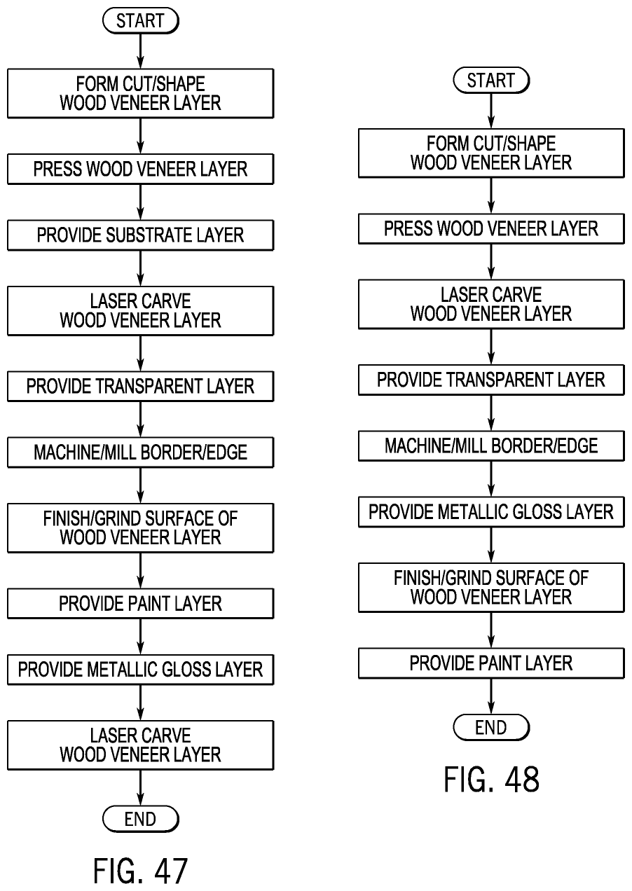

As indicated schematically in FIG. 47, a method of producing component C with composite structure CS comprising cover T may may comprise step of forming/cutting/shaping wood veneer layer TW (step S0); step of pressing wood veneer layer TW (step S1); step of providing substrate layer such as base layer TB and/or resin substrate layer (step S2A); step of laser carving wood veneer layer TW (step S7); step of providing transparent layer such as light guide/light-transmissive material TG and/or light-transmissive resin layer (step S2B); step of machining/milling border/edge (step S3); step of finishing/grinding surface of wood veneer layer TW (step S4); step of providing paint layer such as coating TP (step S5); step of providing metallic gloss layer such as deposit TK and/or coating TV (step S6); and step of laser carving wood veneer layer TW (step S7).

As indicated schematically in FIG. 48, a method of producing component C with composite structure CS comprising cover T may may comprise step of forming/cutting/shaping wood veneer layer TW (step S0); step of pressing wood veneer layer TW (step S1); step of laser carving wood veneer layer TW (step S7); step of providing transparent layer such as light guide/light-transmissive material TG and/or light-transmissive resin layer (step S2B); step of machining/milling border/edge (step S3); step of providing metallic gloss layer such as deposit TK and/or coating TV (step S6); step of finishing/grinding surface of wood veneer layer TW (step S4); and step of providing paint layer such as coating TP (step S5).

According to an exemplary embodiment as shown schematically in the FIGURES, component C may comprise composite structure CS comprising cover T; cover T may comprise base layer TB and cover layer TX; cover layer TX may comprise wood/veneer layer TW, light-transmissive wood/veneer layer TL, coating TP, coating TV, deposit TK, light guide/light-transmissive material TG, mask TM, trim line TD and/or trim TR; coating TP may comprise coating, paint, paint layer, coating as applied, treatment, surface treatment layer, protective layer, light-transmissive coating layer, transparent coating, topcoat, film, etc.; coating TV may comprise coating, PVD layer, deposited layer, PVD coating layer, PVD spray coating layer, PVD film, PVD membrane, PVD diaphragm, vapor-deposited layer, vacuum evaporation coating, metal-color coating, etc.; deposit TK may comprise deposit, deposit of material, ink layer, ink material, transfer layer, ink transfer layer, pad printing layer, ink pad printing layer, metallic ink layer, printed metallic ink layer, metal-color deposit, decorative gloss layer, metallic gloss layer, etc.; trim strip/line TD may comprise a line, decorative line, illuminated line, divider line, trim strip, metallic strip, metal-color line, light-transmitting line, etc.; trim TR may comprise edge, border, trim rail, rail, local trim portion, etc.

According to an exemplary embodiment as shown schematically in the FIGURES, cover layer TX may comprise a coating; the coating may comprise an applied material; the coating may comprise paint and/or ink material and/or deposited material and/or film; the coating may comprise paint and ink material and/or deposited material; cover layer TX may comprise the coating; cover layer TX may be provided on base layer TB; cover layer TX may comprise a coating configured to provide the exterior surface for cover T; base layer TB may comprise a veneer; base layer TB may comprise a veneer layer; base layer TB may comprise a veneer material; base layer TB may comprise a wood material; base layer TB may comprise a natural wood material; base layer TB may comprise a wood veneer material; base layer TB may comprise light-transmissive material; base layer TB may comprise light-transmissive material comprising veneer material; base layer TB may comprise light-transmissive material comprising wood veneer material; base layer TB may comprise a formed material; cover layer TX may be formed on base layer TB; cover layer TX may be applied on base layer TB.

According to an exemplary embodiment as shown schematically in the FIGURES, base layer TB may comprise a substrate layer; composite structure CS may comprise a substrate for cover T; base layer TB may comprise light-transmissive material within a veneer material; base layer TB may comprise light-transmissive material under a veneer material; cover T may comprise a profile; the profile of cover T may comprise a generally flat profile; the profile of cover T may comprise a generally flat surface; the profile of cover T may comprise a contoured profile; the profile of cover T may comprise a multi-faceted profile; the profile of cover T may comprise a multi-surface profile; cover T may comprise a light-transmissive section; cover T may comprise a light guide; cover T may comprise light-transmissive material; base layer TB of cover T may comprise a light-transmissive section; base layer TB of cover T may comprise a light guide; the light guide may be within base layer TB of cover T; the light guide may be under base layer TB of cover T; the light guide may be under cover layer TX of cover T; cover T may comprise intermediate layer TN comprising light-transmissive material; cover T may comprise intermediate layer TN comprising a light-transmissive material such as light guide TG or other material.

According to an exemplary embodiment as shown schematically in the FIGURES, component for a vehicle interior may a composite structure; the composite structure may comprise a base layer and cover layer; the cover layer may comprise an exterior surface; the cover may be configured to provide a surface effect for the exterior surface comprising a visual effect and/or performance effect; the visual effect may comprise a decorative effect such as texture, grain, wood, metallic, etc.; the cover may comprise an applied/deposited material such as a coating, paint, ink, film, etc. The base layer may comprise wood material/veneer. A light source may be configured to provide illumination for the cover; the cover may comprise light-transmissive material. The cover may comprise a feature such as a line, strip, inlay, layer, etc. as a decorative feature; the feature may comprise a layer of material at the cover layer and/or within the cover; the feature may be illuminated by the light source.

### Exemplary Embodiments—A

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the surface effect may be provided at the exterior surface of the cover and/or under the exterior surface of the cover; the visual effect may comprise a decorative effect for the cover; the cover may comprise a material comprising an applied material and/or a deposited material and/or a coating and/or a paint and/or an ink material and/or a deposited material and/or a film. The base layer may comprise a wood material and/or a veneer and/or a wood veneer. The component may comprise a light source configured to provide illumination at the cover of the composite structure; the cover may comprise a light guide and/or a light-transmissive material. The base layer may comprise a light-transmissive material comprising a wood veneer material. The composite structure may comprise a substrate for the cover. The cover may comprise a feature configured to provide the surface effect; the feature may comprise a line and/or a strip and/or a layer and/or a trim strip and/or a trim line and/or a decorative feature and/or a decorative line and/or an inlaid material and/or a set of lines and/or a set of strips and/or a set of layers and/or a set of trim strips and/or a set of trim lines. The feature may comprise a layer of material and/or an applied material and/or a deposit of material. The feature may comprise a decorative feature at the cover layer of the cover and/or on the exterior surface of the cover and/or within the cover and/or on the base layer of the cover and/or under the base layer of the cover and/or a decorative feature configured to be illuminated by a light source and/or a trim strip and/or a decorative line and/or a trim line configured to be illuminated by a light source. The visual effect may comprise an illumination effect and/or a color effect and/or a gloss effect and/or a luster effect and/or a dynamic decorative effect and/or an illumination effect and/or a dynamic illumination effect and/or a texture effect and/or a grain effect and/or a gloss effect and/or a contrast effect and/or a wood grain effect and/or a metallic effect and/or a trim strip effect and/or a divider line effect and/or an inlaid appearance effect and/or a metal-like appearance effect and/or a wood-like appearance effect and/or an embedded metallic appearance effect. The decorative effect may comprise a static effect and/or a dynamic effect and/or a texture effect and/or a color effect and/or a luster effect and/or a gloss effect and/or a matte effect and/or a grain effect and/or a wood grain effect and/or a metal effect and/or a metallic texture effect. The performance effect may comprise protection for the exterior surface and/or a tactile effect and/or a texture effect. The cover may comprise a paint layer and/or a coating layer and/or a PVD layer and/or an ink layer and/or a light-transmissive layer and/or a mask layer and/or an opaque layer. The cover may comprise at least one facet at the exterior surface configured to provide a visual effect and/or at least one section at the exterior surface configured to provide a plurality of visual effect. The cover may comprise a feature between each facet of the exterior surface and/or each section of the exterior surface; the feature may comprise a trim strip and/or a divider line. The base layer may comprise a molded layer comprising a polymer material and/or a molded material and/or an injection molded material and/or a film and/or a polymer material and/or an elastomer and/or a thermo-resin elastomer and/or a resin layer and/or a substrate section and/or a structural section and/or a light-transmissive section and/or an opaque section and/or a non-light-transmissive section and/or an opaque section and a light-transmissive section and/or a resin substrate layer and/or an opaque resin substrate layer. The decorative effect of the cover may comprise a metallic decorative effect and/or a wood grain effect. The cover layer of the cover may comprise a coating and/or an ink layer and/or a coating layer and/or a treatment layer and/or a protective layer and/or a light-transmissive coating layer and/or a paint layer and/or an ink layer and/or a PVD layer and/or a gloss layer and/or a color gloss layer and/or a metal color layer and/or a metallic ink layer and/or a printed metallic ink layer. The cover may be configured to provide the visual effect as an ambient effect when cover is unilluminated by the light source and the visual effect as an illuminated effect when the cover is illuminated by the light source. The surface effect of the composite structure is configured to comprise a wood grain effect and/or a gloss effect when unilluminated by the light source and a metallic effect and/or a reflective effect when illuminated by the light source. The component may be produced by a method comprising the steps of: providing a base layer material for the base layer of the cover; providing a cover layer material for the cover layer of the cover on the base layer of the cover; the step of providing the cover layer material on the base layer may comprise forming the cover layer on the base layer; the cover layer material may comprise at least one of a coating and/or a paint layer and/or an ink layer and/or a PVD material and/or a deposited material and/or an applied material and/or a spray-applied material; the cover is configured to provide the surface effect for the composite structure. The component may be produced by a method comprising the steps of: providing a base layer material for the base layer of the cover; providing a cover layer material for the cover layer of the cover on the base layer of the cover; providing the feature for the cover; the step of providing the cover layer material on the base layer may comprise forming the cover layer on the base layer; the cover layer material may comprise at least one of a coating and/or a paint layer and/or an ink layer and/or a PVD material and/or a deposited material and/or an applied material and/or a spray-applied material; the cover is configured to provide the surface effect for the composite structure; the feature may comprise a trim line configured to provide the decorative effect for the cover.

According to an exemplary embodiment as shown schematically in the FIGURES, a component for a vehicle interior may comprise a composite structure comprising a cover and a substrate; the cover may comprise a base layer and a cover layer; the cover layer may be configured to provide an exterior surface for the cover; the cover may be configured to provide a surface effect for the exterior surface; the surface effect may comprise a visual effect and/or a performance effect; the surface effect may be provided at the exterior surface of the cover and/or under the exterior surface of the cover; the visual effect may comprise a decorative effect for the cover; the cover may comprise a material comprising an applied material and/or a deposited material and/or a coating and/or a paint and/or an ink material and/or a deposited material and/or a film. The base layer may comprise a wood material and/or a veneer and/or a wood veneer. The component may comprise a light source configured to provide illumination at the cover of the composite structure; the cover may comprise a light guide and/or a light-transmissive material. The base layer may comprise a light-transmissive material comprising a wood veneer material. The composite structure may comprise a substrate for the cover. The cover may comprise a feature configured to provide the surface effect; the feature may comprise a line and/or a strip and/or a layer and/or a trim strip and/or a trim line and/or a decorative feature and/or a decorative line and/or an inlaid material and/or a set of lines and/or a set of strips and/or a set of layers and/or a set of trim strips and/or a set of trim lines. The feature may comprise a layer of material and/or an applied material and/or a deposit of material. The feature may comprise a decorative feature at the cover layer of the cover and/or on the exterior surface of the cover and/or within the cover and/or on the base layer of the cover and/or under the base layer of the cover and/or a decorative feature configured to be illuminated by a light source and/or a trim strip and/or a decorative line and/or a trim line configured to be illuminated by a light source. The cover may comprise at least one facet at the exterior surface configured to provide a visual effect and/or at least one section at the exterior surface configured to provide a plurality of visual effect. The feature of the cover may be provided between each facet of the exterior surface and/or each section of the exterior surface. The decorative feature may comprise a visual line for the cover and/or a decorative line for the composite structure and/or a trim line and/or a surface layer on the cover and/or an intermediate layer in the cover and/or an intermediate layer under the cover and/or a straight line and/or a set of lines for the cover and/or a feature configured to be illuminated and/or a surface layer material and/or an inlaid material and/or an intermediate layer material. The cover may comprise an intermediate layer configured to provide the surface effect. The visual effect may comprise an illumination effect and/or a color effect and/or a gloss effect and/or a luster effect and/or a dynamic decorative effect and/or an illumination effect and/or a dynamic illumination effect and/or a texture effect and/or a grain effect and/or a gloss effect and/or a contrast effect and/or a wood grain effect and/or a metallic effect and/or a trim strip effect and/or a divider line effect and/or an inlaid appearance effect and/or a metal-like appearance effect and/or a wood-like appearance effect and/or an embedded metallic appearance effect. The cover may comprise a feature between each facet of the exterior surface and/or each section of the exterior surface; the feature may comprise a trim strip and/or a divider line and/or an appearance of metal embedded in a cover material and/or an appearance of metal embedded in veneer and/or an appearance of metal embedded in wood veneer and/or a wood appearance from a wood material and/or a wood appearance from a non-wood material and/or a metal appearance from a non-metal material and/or a natural wood inlaid metal appearance and/or a metallic decorative effect and/or a metallic decorative strip effect and/or a metallic decorative effect when the component is unilluminated by the light source and/or an illuminated metallic decorative effect when the component is illuminated by the light source and/or a wood grain effect combined with a metallic effect and/or a wood grain effect combined with a metallic light transmitting effect. The decorative effect may comprise a static effect and/or a dynamic effect and/or a texture effect and/or a color effect and/or a luster effect and/or a gloss effect and/or a matte effect and/or a grain effect and/or a wood grain effect and/or a metal effect and/or a metallic texture effect. The performance effect may comprise protection for the exterior surface and/or a tactile effect and/or a texture effect. The cover may comprise a paint layer and/or a coating layer and/or a PVD layer and/or an ink layer and/or a light-transmissive layer and/or a mask layer and/or an opaque layer. The cover layer may be formed on the base layer; the cover layer may comprise a film and/or a coating and/or an exterior layer and/or an applied layer and/or a formed layer and/or a molded layer and/or a coating layer; and/or a treatment layer and/or a veneer layer and/or a wood layer and/or a wood veneer layer and/or a light-transmissive veneer layer and/or a light-transmissive wood veneer layer and/or a coating layer comprising at least one of a paint layer or a PVD layer or an ink layer and/or a light guide material and/or a light-transmissive material and/or a mask and/or a shielding layer and/or a plurality of cover surface regions configured to provide a plurality of visual effects and/or a trim line and/or a decorative line and/or an illuminated line and/or a divider line and/or a line between adjacent cover surface regions and/or a trim line configured to provide a metallic visual effect; and/or a trim line configured to transmit light and/or trim and/or trim at an edge of the composite structure and/or trim configured to provide a metallic visual effect and/or trim configured to provide an illuminated visual effect. The cover may comprise a wood veneer layer and/or a light-transmissive wood veneer layer and/or a coating layer and/or an ink layer. The base layer may comprise a molded layer comprising a polymer material and/or a molded material and/or an injection molded material and/or a film and/or a polymer material and/or an elastomer and/or a thermo-resin elastomer and/or a resin layer and/or a substrate section and/or a structural section and/or a light-transmissive section and/or an opaque section and/or a non-light-transmissive section and/or an opaque section and a light-transmissive section and/or a resin substrate layer and/or an opaque resin substrate layer. The decorative effect of the cover may comprise a metallic decorative effect and/or a wood grain effect. The cover layer may comprise a coating comprising an ink layer and/or a coating layer comprising a treatment layer and/or a surface treatment layer and/or a protective layer and/or a light-transmissive coating layer and/or a light-transmissive protective layer and/or a paint layer and/or a layer configured to fill a texture of the wood veneer layer and/or a layer configured to fill a texture of the wood veneer layer and/or a layer configured to provide a flat exterior surface and/or a layer configured to protect the wood veneer layer and/or a layer configured to protect the ink layer and/or PVD layer. The cover layer may comprise an ink layer comprising a decorative gloss layer and/or a color gloss layer and/or a metal color gloss layer and/or a metallic gloss layer and/or a surface treatment layer and/or a coating and/or a metal-color coating and/or a metallic coating and/or a transfer layer and/or an ink transfer layer and/or a pad printing layer and/or an ink pad printing layer and/or a metallic ink layer and/or a printed metallic ink layer and/or a layer pad-printed on the wood veneer layer and/or a layer pad-printed on the coating layer. The cover is configured to provide the visual effect when the component is unilluminated by the light source and/or a light transmitting gloss effect when the component is illuminated by the light source and/or a static visual effect when the component is unilluminated by the light source and a dynamic visual effect when the component is illuminated by the light source. The cover layer may comprise a deposited layer comprising a PVD layer comprising a vapor deposited layer and/or a vacuum evaporation coating and/or a PVD coating layer and/or a PVD spray coating layer and/or a PVD film layer and/or a PVD membrane and/or a PVD diaphragm and/or a layer between the coating layer and the wood veneer layer and/or a layer between the wood veneer layer and the base layer and/or a layer between the base layer and a light-transmissive section and/or a layer configured to provide a metallic decorative effect. The ink layer and/or the PVD layer may be on the coating layer and/or at the exterior surface and/or between the coating layer and the wood veneer layer and/or at the exterior surface of the cover and/or under the coating layer and/or under the wood veneer layer and/or under the base layer and/or under a light-transmissive section of the base layer and/or aligned with a light-transmitting region of the cover and/or aligned with a light-transmissive section of the base layer. The ink layer and/or the PVD layer may comprise a decorative feature and/or a decorative line and/or a trim feature and/or a trim line and/or is at the trim. The surface effect of the composite structure may be configured to comprise a wood grain effect and/or a gloss effect when unilluminated by the light source and a metallic effect when illuminated by the light source. The substrate may comprise a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate; the component may comprise an instrument panel and/or a door panel and/or a console and/or a floor console and overhead console and/or an armrest and/or a trim insert and/or a trim panel and/or a trim component. The component may be produced by a method comprising the steps of: providing a base layer material for the base layer of the cover; providing a cover layer material for the cover layer of the cover on the base layer of the cover; the step of providing the cover layer material on the base layer may comprise forming the cover layer on the base layer; the cover layer material may comprise at least one of a coating and/or a paint layer and/or an ink layer and/or a PVD material and/or a deposited material and/or an applied material and/or a spray-applied material; the cover may be configured to provide the surface effect for the composite structure. The component may comprises a composite structure comprising a substrate comprising a structural substrate and a cover; the cover may comprise a base layer and a cover layer; the base layer may comprise a wood veneer layer; the cover layer may comprise a coating; the composite structure may comprise a visual effect for the cover comprising a natural/real wood effect; the wood veneer layer of the composite structure may comprise a wood skin layer; the coating may comprise a paint layer and/or a gloss layer and/or a metallic layer and/or a metallic gloss layer and/or an ink layer and/or an ink transfer layer and/or a spray coating layer and/or a deposit layer and/or a PVD coating layer and/or a PVD spray coating layer.

According to an exemplary embodiment, a vehicle interior may comprise a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the surface effect may be provided at the exterior surface of the cover and/or under the exterior surface of the cover; the visual effect may comprise a decorative effect for the cover; the base layer may comprise a wood material; the cover layer may comprise a coating configured to provide the exterior surface for the cover; the cover may comprise a coating comprising an applied material and/or a paint and/or an ink material and/or a deposited material and/or film; the base layer may comprise a light-transmissive material comprising a veneer material; the composite structure may comprise a substrate for the cover; the cover may comprise a light guide further comprising a light source configured to provide illumination at the cover of the composite structure; the cover may comprise a feature configured to provide the surface effect; the feature may comprise a layer and/or a layer of material and/or an applied material and/or a deposit and/or a deposit of material; the feature may be on the cove layer of the cover and/or on the exterior surface of the cover and/or within the cover and/or on the base layer of the cover and/or under the base layer of the cover; the feature may comprise a line on the composite structure and/or a decorative line on the composite structure; the decorative line may comprise a visual line for the cover and/or a trim line and/or a surface layer on the cover and/or an intermediate layer in the cover and/or an intermediate layer under the cover and/or a straight line and/or a set of lines for the cover and/or may be configured to be illuminated and/or a material and/or an surface layer material and/or an inlaid material and/or an intermediate layer material; the cover may comprise an intermediate layer configured to provide the surface effect; the visual effect may comprise the decorative effect and/or an illumination effect and/or a color effect and/or a dynamic decorative effect and/or a dynamic illumination effect and/or a texture effect and/or a color gloss effect and/or a light dark contrast effect and/or a gray scale contrast effect and/or a trim strip effect and/or a divider line effect and/or an inlaid appearance effect and/or a metal-like appearance effect; and/or a wood-like appearance effect; and/or a metallic appearance effect and/or an appearance of metal embedded in a cover material and/or an appearance of metal embedded in veneer and/or an appearance of metal embedded in wood veneer and/or a wood appearance from a wood material and/or a wood appearance from a non-wood material; and/or a metal appearance from a non-metal material and/or a natural wood inlaid metal appearance and/or a metallic decorative effect and/or a metallic decorative strip effect and/or a metallic decorative effect when the component may be unilluminated by the light source and/or an illuminated metallic decorative effect when the component may be illuminated by the light source and/or a wood grain effect combined with a metallic effect and/or a wood grain effect combined with a metallic light transmitting effect; the decorative effect may comprise a static effect and/or a dynamic effect and/or a texture effect and/or a color effect and/or a luster effect and/or a gloss effect and/or a matte effect and/or a grain effect and/or a wood grain effect and/or a metal effect and/or a metallic texture effect; the performance effect may comprise protection for the exterior surface and/or a tactile effect and/or a texture effect; the cover layer may be formed on the base layer and may comprise a film and/or a coating and/or an exterior layer and/or an applied layer and/or a formed layer and/or a molded layer and/or a coating layer; and/or a treatment layer and/or a veneer layer and/or a wood layer and/or a wood veneer layer and/or a light-transmissive veneer layer and/or a light-transmissive wood veneer layer and/or a coating layer comprising at least one of: (1) a paint layer; (2) a PVD layer; (3) an ink layer and/or a light guide material and/or a light-transmissive material and/or a mask and/or a shielding layer and/or a plurality of cover surface regions configured to provide a plurality of visual effects and/or a trim line and/or a decorative line and/or an illuminated line and/or a divider line and/or a line between adjacent cover surface regions and/or a trim line configured to provide a metallic visual effect; and/or a trim line configured to transmit light and/or trim and/or trim at an edge of the composite structure and/or trim configured to provide a metallic visual effect and/or trim configured to provide an illuminated visual effect; the cover may comprise a wood veneer layer and/or a light-transmissive wood veneer layer and/or a coating layer and/or an ink layer; the base layer may comprise a molded layer comprising a polymer material and/or a molded material and/or an injection molded material and/or a film and/or a polymer material and/or an elastomer and/or a thermo-resin elastomer and/or a resin layer and/or a substrate section and/or a structural section and/or a light-transmissive section and/or an opaque section and/or a non-light-transmissive section and/or an opaque section and a light-transmissive section and/or a resin substrate layer and/or an opaque resin substrate layer; the cover layer may be configured to provide a metallic decorative effect; the cover layer may comprise a coating comprising an ink layer and/or a coating layer comprising a treatment layer and/or a surface treatment layer and/or a protective layer and/or a light-transmissive coating layer and/or a light-transmissive protective layer and/or a paint layer and/or a layer configured to fill a texture of the wood veneer layer and/or a layer configured to fill a texture of the wood veneer layer and/or a layer configured to provide a flat exterior surface and/or a layer configured to protect the wood veneer layer and/or a layer configured to protect the ink layer and/or PVD layer; the cover layer may comprise an ink layer comprising a decorative gloss layer and/or a color gloss layer and/or a metal color gloss layer and/or a metallic gloss layer and/or a surface treatment layer and/or a coating and/or a metal-color coating and/or a metallic coating and/or a transfer layer and/or an ink transfer layer and/or a pad printing layer and/or an ink pad printing layer and/or a metallic ink layer and/or a printed metallic ink layer and/or a layer pad-printed on the wood veneer layer and/or a layer pad-printed on the coating layer; the cover may be configured to provide the visual effect when the component may be unilluminated by the light source and/or a light transmitting gloss effect when the component may be illuminated by the light source and/or a static visual effect when the component may be unilluminated by the light source and a dynamic visual effect when the component may be illuminated by the light source; the cover layer may comprise a deposited layer comprising a PVD layer comprising a vapor deposited layer and/or a vacuum evaporation coating and/or a PVD coating layer and/or a PVD spray coating layer and/or a PVD film layer and/or a PVD membrane and/or a PVD diaphragm and/or a layer between the coating layer and the wood veneer layer and/or a layer between the wood veneer layer and the base layer and/or a layer between the base layer and a light-transmissive section and/or a layer configured to provide a metallic decorative effect; the ink layer and/or the PVD layer may be on the coating layer and/or at the exterior surface and/or between the coating layer and the wood veneer layer and/or at the exterior surface of the cover and/or under the coating layer and/or under the wood veneer layer and/or under the base layer and/or under a light-transmissive section of the base layer and/or aligned with a light-transmitting region of the cover and/or aligned with a light-transmissive section of the base layer; the ink layer and/or the PVD layer may comprise a decorative feature and/or a decorative line and/or a trim feature and/or a trim line and/or may be at the trim; the composite structure may be configured to provide a wood grain effect and/or a gloss effect when illuminated by the light source and/or a metallic effect when illuminated by the light source and/or a metallic effect at the wood veneer layer; the substrate may comprise a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate; the component may comprise an instrument panel and/or a door panel and/or a console and/or a floor console and overhead console and/or an armrest and/or a trim insert and/or a trim panel and/or a trim component.

### Exemplary Embodiments—B

According to an exemplary embodiment as shown schematically in the FIGURES, a component for a vehicle interior may comprise a composite structure comprising a substrate and a cover; the cover may comprise a base layer and a cover layer; the cover layer may be configured to provide an exterior surface; the cover may be configured to provide a surface effect for the exterior surface; the surface effect may comprise a visual effect and/or a performance effect; the substrate may comprise a structural substrate.

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the cover may be configured to provide a surface effect for the exterior surface; the surface effect may comprise a visual effect and/or a performance effect; the visual effect may comprise a decorative effect for the cover; the surface effect may be provided at the exterior surface of the cover and/or under the exterior surface of the cover; the surface effect may be provided within the cover; the surface effect may be provided within the cover layer of the cover and/or within the base layer of the cover; the surface effect may be provided at an intermediate layer of the cover; the visual effect may be provided at the exterior surface of the cover; the visual effect may be provided under the exterior surface of the cover; the visual effect may be provided within the cover; the visual effect may be provided within the cover layer of the cover; the visual effect may be provided within the base layer of the cover; the visual effect may be provided at an intermediate layer of the cover; the cover may comprise a coating; the coating may comprise an applied material; the coating may comprise a paint and/or an ink material and/or a deposited material and/or film; the coating may comprise a paint and an ink material and/or a deposited material; the cover layer may comprise the coating; the cover layer may be provided on the base layer; the cover layer may comprise the exterior surface for the cover; the cover layer may comprise a coating configured to provide the exterior surface for the cover; the base layer may comprise a veneer; the base layer may comprise a veneer layer; the base layer may comprise a veneer material; the base layer may comprise a wood material; the base layer may comprise a natural/real wood material; the base layer may comprise a wood veneer material; the base layer may comprise a light-transmissive material; the base layer may comprise a light-transmissive material comprising a veneer material; the base layer may comprise a light-transmissive material comprising a wood veneer material; the base layer may comprise a formed material; the cover layer may be formed on the base layer; the cover layer may be applied on the base layer; the base layer may comprise a substrate layer; the composite structure may comprise a substrate for the cover; the base layer may comprise a light-transmissive material within a veneer material; the base layer may comprise a light-transmissive material under a veneer material.

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the cover may comprise a profile; the profile of the cover may comprise a generally flat profile; the profile of the cover may comprise a generally flat surface; the profile of the cover may comprise a contoured profile; the profile of the cover may comprise a multi-faceted profile; the profile of the cover may comprise a multi-surface profile; the cover may comprise a light-transmissive section; the cover may comprise a light guide; the cover may comprise a light-transmissive material; the base layer of the cover may comprise a light-transmissive section; the base layer of the cover may comprise a light guide; the light guide may be within the base layer of the cover; the light guide may be under the base layer of the cover; the light guide may be under the cover layer of the cover; the cover may comprise an intermediate layer comprising a light-transmissive material; the cover may comprise an intermediate layer comprising a light guide; the component may further comprise a light source configured to provide illumination at the cover of the composite structure; the component may further comprise a light source configured to provide illumination for the cover of the composite structure; the component may further comprise a light source configured to provide illumination at the exterior surface of the cover of the composite structure; the cover may comprise a feature configured to provide the surface effect; the feature may comprise a layer; the feature may comprise a layer of material; the feature may comprise an applied material; the feature may comprise a deposit; the feature may comprise a deposit of material; the feature may be on the cover layer of the cover; the feature may be on the exterior surface of the cover; the feature may be within the cover; the feature may be on the base layer of the cover; the feature may be under the base layer of the cover; the feature may comprise a line on the composite structure; the feature may comprise a decorative line on the composite structure; the decorative line may comprise a visual line for the cover; the decorative line may comprise a trim line; the decorative line may comprise a surface layer on the cover; the decorative line may comprise an intermediate layer in the cover; the decorative line may comprise an intermediate layer under the cover; the decorative line may comprise a straight line; the decorative line may comprise a set of lines for the cover; the decorative line may be configured to be illuminated; the decorative line may comprise a material; the decorative line may comprise an surface layer material; the decorative line may comprise an inlaid material; the decorative line may comprise an intermediate layer material; the base layer and the cover layer may be configured to provide the surface effect; the cover layer may be configure to provide the surface effect; the base layer and the cover layer and a light guide may be configured to provide the surface effect; the cover may comprise an intermediate layer configured to provide the surface effect; the surface effect may comprise a decorative effect; the visual effect may comprise the decorative effect; the visual effect may comprise an illumination effect; the decorative effect may comprise a static effect; the decorative effect may comprise a dynamic effect; the decorative effect may comprise a color effect; the decorative effect may comprise a texture effect; the decorative effect may comprise a luster effect; the decorative effect may comprise a gloss effect; the decorative effect may comprise a matte effect; the decorative effect may comprise grain effect; the decorative effect may comprise wood grain effect; the decorative effect may comprise metal effect; the decorative effect may comprise metallic texture effect; the visual effect may comprise a color effect; the visual effect may comprise a dynamic decorative effect; the visual effect may comprise a dynamic illumination effect; the performance effect may comprise protection for the exterior surface; the performance effect may comprise protection for the exterior surface; the performance effect may comprise a tactile effect; the performance effect may comprise a texture effect; the tactile effect may comprise a texture effect; the visual effect may comprise a texture effect; the texture effect may comprise a grain effect and/or a metallic effect; the texture effect may comprise a grain effect and a metallic effect; the visual effect may comprise color and/or a texture effect and/or a grain effect; the visual effect may comprise a gloss effect and/or color gloss effect; the visual effect may comprise a light dark contrast effect; the visual effect may comprise a gray scale contrast effect; the visual effect may comprise a trim strip effect; the visual effect may comprise a divider line effect; the visual effect may comprise an inlaid appearance effect; the visual effect may comprise a metal-like appearance effect; the visual effect may comprise a wood-like appearance effect; the visual effect may comprise a metallic appearance effect; the visual effect may comprise an appearance of metal embedded in a cover material; the visual effect may comprise an appearance of metal embedded in veneer; the visual effect may comprise an appearance of metal embedded in wood veneer; the visual effect may comprise a wood appearance from a wood material; the visual effect may comprise a wood appearance from a non-wood material; the visual effect may comprise a metal appearance from a non-metal material; the visual effect may comprise a natural/real wood inlaid metal appearance; the visual effect may comprise a metallic decorative effect; the visual effect may comprise a metallic decorative strip effect; the visual effect may comprise a metallic decorative effect when the component may be unilluminated by the light source; the visual effect may comprise an illuminated metallic decorative effect when the component may be illuminated by the light source; the visual effect may comprise a wood grain effect combined with a metallic effect; the visual effect may comprise a wood grain effect combined with a metallic light transmitting effect; the cover may comprise an intermediate layer configured to provide the surface effect; the intermediate layer may comprise an opaque layer; the cover may comprise an opaque layer; the cover may comprise an opaque material; the opaque material may comprise a mask layer; the intermediate layer may comprise a mask layer; the surface effect may be provided by the cover layer; the performance effect may be provided by the cover layer and/or the base layer; the cover layer may comprise a film and/or a coating and/or an exterior layer; the cover layer may be formed on the base layer; the cover layer may comprise an applied layer; the cover layer may comprise a formed layer; the cover layer may comprise a molded layer; the cover layer may comprise a coating layer; the cover layer may comprise a treatment layer; the cover layer may comprise a veneer layer; the cover layer may comprise a wood layer; the cover layer may comprise a wood veneer layer; the cover layer may comprise a light-transmissive veneer layer; the cover layer may comprise a light-transmissive wood veneer layer; the cover layer may comprise a coating layer.

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the cover layer may comprise a coating layer comprising a paint layer; the cover layer may comprise a coating layer comprising a PVD layer; the cover layer may comprise a deposit layer comprising an ink layer; the cover layer may comprise a light guide material; the cover layer may comprise a light-transmissive material; the cover layer may comprise a mask; the cover layer may comprise a shielding layer; the cover may comprise a wood veneer layer and a coating layer; the cover may comprise a wood veneer layer and a PVD layer; the cover may comprise a wood veneer layer and an ink layer; the cover may comprise a coating layer and an ink layer; the cover may comprise a coating layer and a PVD layer; the cover may comprise a base layer and a wood veneer layer and a coating layer and an ink layer; the cover may comprise a base layer and a light-transmissive wood veneer layer and a coating layer and an ink layer; the cover may comprise a base layer and a wood veneer layer and a coating layer and a PVD layer; the cover layer may comprise a plurality of cover surface regions configured to provide a plurality of visual effects; the cover layer may comprise a trim line; the cover layer may comprise a decorative line; the cover layer may comprise an illuminated line; the cover layer may comprise a divider line; the cover layer may comprise a line between adjacent cover surface regions; the cover layer may comprise a trim line configured to provide a metallic visual effect; the cover layer may comprise a trim line configured to transmit light; the cover layer may comprise trim; the cover layer may comprise trim at an edge of the composite structure; the cover layer may comprise trim configured to provide a metallic visual effect; the cover layer may comprise trim configured to provide an illuminated visual effect; the base layer may comprise a molded layer comprising a polymer material and/or a molded material and/or an injection molded material and/or a film and/or a polymer material and/or an elastomer and/or a thermo-resin elastomer; the base layer may comprise a resin layer; the base layer may comprise a substrate section; the base layer may comprise a structural section; the base layer may comprise a light-transmissive section; the base layer may comprise a light transmitting section; the base layer may comprise a light-transmissive material; the base layer may comprise an opaque section; the opaque section may comprise a non-light-transmissive section; the base layer may comprise a non-light-transmissive section; the base layer may comprise an opaque section and a light-transmissive section; the base layer may comprise a resin substrate layer; the base layer may comprise an opaque resin substrate layer; the base layer may comprise a non-light-transmissive resin substrate layer; the base layer may comprise a resin substrate layer; the light-transmissive material of the base layer may comprise a light transmitting resin layer; the base layer may comprise a resin substrate layer and a light-transmissive material; the base layer may comprise a light-transmissive resin layer within a resin substrate layer; the base layer may comprise a light-transmissive material at the cover layer; the base layer may comprise a light-transmissive material at an ink layer and/or the PVD layer; the base layer may be configured to provide structural support for the cover layer; the base layer may comprise a masking section and/or shielding section.

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the base layer may comprise a veneer layer; the cover layer may comprise a veneer layer; the base layer may comprise a wood layer; the veneer layer may comprise a wood veneer layer; the wood layer may comprise a wood veneer layer; the wood layer may comprise a natural/real wood layer; the wood layer may comprise a wood layer; the wood layer may comprise a natural/real wood veneer; the wood layer may comprise a wood skin layer; the wood layer may comprise an ordinary veneer layer; the wood layer may comprise an natural/real wood layer; the cover layer may comprise an opaque veneer layer; the cover layer may comprise an opaque wood veneer layer; the cover layer may comprise a light transmitting veneer layer; the cover layer may comprise a light transmitting wood veneer layer; the cover layer may comprise a translucent veneer layer; the cover layer may comprise a translucent wood veneer layer; the cover layer may be configured to provide a natural grain effect and/or wood grain effect and/or natural wood appearance texture; the cover layer may be non-planar; the cover layer may be formed into a profile comprising a shape; the cover layer may be hot pressed into a profile comprising a shape; the cover layer may comprise a light-transmitting region and/or non-light-transmitting region; the wood veneer layer may comprise a light-transmitting region and/or non-light-transmitting region; the cover layer may comprise an opening and/or a cutout; the cover layer may comprise a hollow region and/or partially hollow region; the cover layer may comprise a laser-carved region and/or laser-engraved region; the cover layer may comprise a hollow region in a light-transmitting region; the cover layer may comprise a non-hollow region adjacent to a hollow region in a light-transmitting region; the cover layer may comprise a shielding section and/or shielding layer; the cover layer may comprise a opaque material and/or non-woven shielding layer and/or ink shielding layer; the light-transmissive wood veneer layer may be configured to transmit light from a substrate side of the cover toward the exterior surface; the light-transmissive wood veneer layer may be configured to transmit light through the ink layer; the light-transmissive wood veneer layer may be configured to transmit light through the PVD layer; the cover layer may be configured to provide a metallic decorative effect without a separate carrier film; the cover layer may be configured to provide a metallic decorative effect without a separate metallic diaphragm; the cover layer may be configured to provide a metallic decorative effect without a metal insert; the cover layer may be translucent and/or light transmitting; the cover layer may be configured to provide the visual effect when the component may be unilluminated by the light source; the cover layer may be configured to provide a light transmitting gloss effect when the component may be illuminated by the light source; the cover layer may be configured to provide a static visual effect when the component may be unilluminated by the light source and a dynamic visual effect when the component may be illuminated by the light source; the cover layer may be configured to provide a static visual effect when the component may be unilluminated by the light source and a dynamic visual effect when the component may be illuminated by the light source; the cover layer may be configured to shield an internal structure when the component may be unilluminated by the light source.

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the cover layer may comprise a coating; the coating of the cover layer may comprise a coating layer; the coating layer may comprise a treatment layer and/or a surface treatment layer; the coating layer may comprise a protective layer and/or a light-transmissive coating layer and/or a light-transmissive protective layer; the coating layer may comprise a paint layer; the coating layer may be configured to fill a texture of the wood veneer layer; the coating layer may be configured to provide a flat exterior surface; the coating layer may be configured to protect the wood veneer layer; the coating layer may be configured to protect the ink layer and/or PVD layer; the cover layer may comprise an ink layer; the ink layer may comprise a decorative gloss layer; the ink layer may comprise a color gloss layer; the ink layer may comprise a metal color gloss layer; the ink layer may comprise a metallic gloss layer; the ink layer may comprise a surface treatment layer; the ink layer may comprise a coating and/or a metal-color coating and/or metallic coating; the ink layer may comprise a transfer layer; the ink layer may comprise an ink transfer layer; the ink layer may comprise a pad printing layer; the ink layer may comprise an ink pad printing layer; the ink layer may comprise a metallic ink layer; the ink layer may comprise a printed metallic ink layer; the ink layer may be pad-printed on the wood veneer layer; the ink layer may be pad-printed on the coating layer; the cover layer may comprise a deposited layer; the cover layer may comprise a PVD layer; the deposited layer may comprise a PVD layer; the PVD layer may comprise a vapor deposited layer and/or a vacuum evaporation coating; the PVD layer may comprise a PVD coating layer; the PVD layer may comprise a PVD spray coating layer; the PVD layer may comprise a PVD film layer and/or a PVD membrane and/or a PVD diaphragm; the PVD layer may be between the coating layer and the wood veneer layer; the PVD layer may be between the wood veneer layer and the base layer; the PVD layer may be between the base layer and a light-transmissive section; the PVD layer may be configured to provide a metallic decorative effect; the ink layer and/or the PVD layer may be in the cover; the ink layer and/or the PVD layer may be on the coating layer; the ink layer and/or the PVD layer may be at the exterior surface; the ink layer and/or the PVD layer may be between the coating layer and the wood veneer layer; the ink layer and/or the PVD layer may be at the exterior surface of the cover; the ink layer and/or the PVD layer may be under the coating layer; the ink layer and/or the PVD layer may be under the wood veneer layer; the ink layer and/or the PVD layer may be under the base layer; the ink layer and/or the PVD layer may be under a light-transmissive section of the base layer; the ink layer and/or the PVD layer may be under a light-transmissive section of the base layer; the ink layer and/or the PVD layer may be aligned with a light-transmitting region of the cover; the ink layer and/or the PVD layer may be aligned with a light-transmissive section of the base layer; the ink layer and/or the PVD layer may comprise a decorative feature; the ink layer and/or the PVD layer may comprise a decorative line; the ink layer and/or the PVD layer may comprise a trim feature; the ink layer and/or the PVD layer may comprise a trim line; the ink layer and/or the PVD layer may be at the trim.

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the cover may comprise a light guide material; the base layer of the cover may comprise a light guide material; the light guide material of the base layer may be configured to direct light to the cover layer; the light guide material may comprise a light-transmissive section of the base layer; the light guide material may comprise a light-transmissive material; the light guide material may be configured to direct light to the trim line of the cover; the light guide material may be configured to direct light to the ink layer of the cover; the light guide material may be configured to direct light to the PVD layer of the cover; the light guide material may be adjacent to a mask layer of the cover; the composite structure may comprise a light-transmitting region; the composite structure may comprise a non-light-transmitting region; the non-light-transmitting region may comprise an opaque region; the composite structure may comprise an opaque region; the composite structure may comprise a light-transmitting region and a non-light-transmitting region; the light source may be configured to transmit light through the base layer; the light source may be configured to transmit light through the light guide material; the light source may be configured to transmit light through the wood veneer layer; the light source may be configured to transmit light through the coating layer; the light source may be configured to transmit light through the ink layer and/or the PVD layer; the composite structure may be configured to provide a wood grain effect and a gloss effect when illuminated by the light source; the composite structure may be configured to provide a wood grain effect and a metallic effect when illuminated by the light source; the composite structure may be configured to provide a metallic effect at the wood veneer layer; the composite structure may be configured to block light in a mask region; the composite structure may be configured to transmit light in a decorative region; the composite structure may be configured to provide an ambient lighting effect; the performance effect may comprise stain resistance and/or fluid repellence and/or hardness and/or softness and/or scratch resistance and/or tactile performance and/or antifouling; the performance effect may comprise light blocking and/or light transmission and/or shielding and/or layer protection and/or scratch protection and/or bonding and/or support and/or structural strength; the surface effect may comprise adhesion evaluation and/or wear resistance and/or stain resistance evaluation and/or water droplet angle and/or feel evaluation and/or texture and/or static friction coefficient and/or dynamic friction coefficient; the substrate may comprise a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate; the component may comprise an instrument panel and/or a door panel and/or a console and/or a floor console and overhead console and/or an armrest and/or a trim insert and/or a trim panel and/or a trim component.

According to an exemplary embodiment as shown schematically in the FIGURES, a component for a vehicle interior may comprise a composite structure comprising a cover; the cover may comprise a base layer and a cover layer; the cover layer may be configured to provide an exterior surface for the cover; the component may be produced by a method comprising the steps of: providing a base layer material for the base layer of the cover; providing cover layer material for the cover layer on the base layer; and providing the cover on a structural substrate; the step of providing the cover layer material on the base layer may comprise forming the cover layer material on the base layer; the step of providing the base layer material may comprise forming the base layer from the base layer material on the structural substrate; and the cover may be configured to provide the surface effect for the composite structure; the method may comprise providing the wood veneer layer and providing a coating layer; the method may comprise providing the coating layer as an ink layer; the method may comprise injection molding a generally opaque material to provide the a substrate and molding a light-transmissive material to provide a light-transmissive section for the cover; the method may comprise applying an ink layer for the cover by ink transfer and/or metallic ink transfer and/or pad printing and/or metallic ink pad printing; the method may comprise applying a PVD layer for the cover by PVD processing and/or the PVD coating and/or the PVD spraying and/or vacuum evaporation coating and/or providing a PVD film and/or providing a PVD diaphragm.

According to an exemplary embodiment as shown schematically in the FIGURES, a component for a vehicle interior may comprise a composite structure comprising a substrate comprising a structural substrate and a cover; the cover may comprise a base layer and a cover layer; the base layer may comprise a wood veneer layer; the cover layer may comprise a coating; the composite structure may comprise a visual effect for the cover comprising a natural wood effect; the wood veneer layer of the composite structure may comprise a wood skin layer; the coating may comprise a paint layer and/or a gloss layer and/or a metallic layer and/or a metallic gloss layer and/or an ink layer and/or an ink transfer layer and/or a spray coating layer and/or a deposit layer and/or a PVD coating layer and/or a PVD spray coating layer; the composite structure may comprise natural wood trim; the cover may comprise the base layer and the wood veneer layer and the paint layer and the metallic gloss layer; the cover may comprise the base layer and the wood skin layer and the paint layer and the metal gloss layer; the cover may comprise a bottom-to-top structure comprising the base layer and the wood veneer layer and the paint layer; the cover may comprise a bottom-to-top structure comprising the base layer and the wood skin layer and the paint layer; the metallic gloss layer may be on the paint layer; the metal gloss layer may be on the paint layer; the base layer may comprise an opaque resin substrate layer; the base layer may comprise a light-transmissive material; the base layer may comprise an opaque resin substrate layer and a light-transmissive material; the metallic gloss layer may be on the base layer when the base layer may comprise the opaque resin substrate layer; the metallic gloss layer may be on or below the base layer when the base layer may comprise the light-transmissive material; the metallic gloss layer may be at least partially in a region corresponding to the light-transmissive material; the wood veneer layer may comprise a shielding layer; the wood skin layer may comprise a shielding layer; the base layer may comprise a resin substrate layer and a light-transmissive material and the metallic gloss layer may be on or below the light-transmissive material; the light-transmissive material may be within the resin substrate layer in a light-transmitting region; the wood veneer layer may comprise natural wood veneer; the wood veneer layer may comprise a light-transmitting wood skin layer; the wood skin layer may comprise an opaque wood veneer and the metal gloss layer may be on the wood veneer; the wood skin layer may comprise an wood veneer having a hollow structure in a light-transmitting region; produced by a method comprising the steps of: providing a base layer on a back side of the wood veneer layer; providing a paint layer on an upper surface of the wood veneer layer; and providing a metallic gloss layer in an ink transfer manner or the PVD spray manner; the method may comprise performing a first insert injection molding on the back side of the wood veneer layer to provide a resin substrate layer; the method may comprise performing a second insert injection molding on the back side of the wood veneer layer to provide a light-transmissive material; the method may comprise performing the first insert injection molding with non-light-transmissive resin; the method may comprise performing the second insert injection molding with light-transmissive resin; the method may comprise hot pressing the wood veneer layer into a desired shape before providing the base layer; the method may comprise laser carving the wood veneer layer; the method may comprise CNC milling a part/component edge after providing the base layer to remove a process edge; the method may comprise grinding an upper surface of the wood veneer layer before providing the paint layer; the method may comprise cutting the wood veneer layer; the method may comprise shading the wood veneer layer.

According to an exemplary embodiment as shown schematically in the FIGURES, a component for an interior of a vehicle may comprise a composite structure configured to provide appearance of natural wooden trim comprising a cover comprising a base layer and a cover layer and a paint layer; the composite structure may comprise a metal gloss layer comprising an ink transfer layer and/or a PVD spray coating layer; the ink transfer layer may be on the paint layer; the cover layer may comprise a wood skin layer; the base layer may comprise an opaque resin substrate layer and/or a resin light-transmissive layer; the base layer may comprise an opaque resin substrate layer and a metallic luster layer may be provided on the base layer; the base layer may comprise a resin light-transmissive layer; the metallic luster layer may be at the base layer; the metallic luster layer may be at least partially in a region corresponding to the resin light-transmissive layer; the wood skin layer may comprise a shielding layer comprising a mask material; the base layer may comprise a resin substrate layer and a resin light-transmissive layer; the metallic luster layer may be at the resin light-transmissive layer; the resin light-transmissive layer may be within the resin substrate layer in the light-transmitting region; the cover layer may comprise a wood veneer and/or a light-transmitting wood veneer; the cover layer may comprise the wood veneer comprising an opaque wood veneer; the metal gloss layer may be on the wood veneer; the wood veneer may comprise an open section to provide a light-transmitting region; the method may comprise the step of providing a base layer for the wood veneer; providing a paint layer for a surface of the wood veneer; and providing a metallic gloss layer as an ink-transfer material and/or a PVD-spray material; the method may comprise: performing an injection molding for the wood veneer to provide a resin substrate layer and performing an injection molding for the wood veneer to provide a resin light-transmissive layer; injection molding may comprise insert injection molding of a non-light-transmissive resin; the method may comprise hot-pressing the wood veneer into a shape before providing the base layer; the method may comprise laser carving the wood veneer; the method may comprise CNC milling a part/component edge after providing the base layer to remove the process edge; the method may comprise grinding an upper surface of the wood veneer before providing the paint layer; the method may comprise cutting the wood veneer and/or shading the wood veneer.

### Exemplary Embodiments—C

According to an exemplary embodiment, a component comprising a composite structure comprising a cover may comprise natural wooden trim component comprising (in an assembly/combination) a base layer and a wood veneer layer and a paint layer; the composite structure with cover configured to provide a natural wood trim component further may comprise a metallic gloss layer; the metallic gloss layer may be an ink transfer layer or a PVD spray coating layer; the ink transfer layer may be located above the paint layer; the base layer may comprise an opaque plastic/resin substrate layer and/or a plastic/resin transparent layer; the base layer may be an opaque plastic/resin substrate layer; the metallic gloss layer may be located above the base layer; when the base layer comprises a plastic/resin transparent layer, the metallic gloss layer may be located above or below the base layer; the metallic gloss layer may be in a region corresponding to the plastic/resin transparent layer; the wood veneer layer may have a shielding layer; when the base layer comprises a plastic/resin substrate layer and a plastic/resin transparent layer, the metallic gloss layer may be located above or below the plastic/resin transparent layer; the plastic/resin transparent layer may be located inside the plastic/resin substrate layer in the light-transmitting region; the wood veneer layer may be an ordinary wood veneer layer or a light-transmitting wood veneer layer; the wood veneer layer may be an opaque common wood veneer layer; the metallic gloss layer may be located above the ordinary wood veneer layer; the ordinary wood veneer layer may be of a hollow structure in the light-transmitting region. The composite structure with cover configured to provide a natural wood trim component may be produced by a method comprising providing a base layer on the back side of the wood veneer layer, providing a paint layer on the upper surface of the wood veneer layer, and providing a metallic gloss layer in an ink-transfer or PVD-spray manner; the method may comprise performing a first insert injection molding on the back side of the wood veneer layer to provide a plastic/resin substrate layer; the method may comprise performing a second insert injection molding on the back side of the wood veneer layer to provide a plastic/resin transparent layer; the method may comprise performing the first insert injection molding with non-transparent plastic/resin; and/or performing the second insert injection molding with transparent plastic/resin; the method may comprise hot-pressing the wood veneer layer into a desired shape before providing the base layer; the method may comprise laser carving the wood veneer layer; the method may comprise CNC milling a part/component edge after providing the base layer to remove the process edge; the method may comprise grinding an upper surface of the wood veneer layer before providing the paint layer; the method may comprise cutting the wood veneer layer and/or shading the wood veneer layer.

According to an exemplary embodiment, a component may provide a composite structure with cover configured to provide a natural wood trim component and a method for manufacturing a composite structure with cover configured to provide an improved natural wood trim component. According to an exemplary embodiment, a component comprising a composite structure may be configured to provide the decorative part/component in the appearance effect of the natural wood embedded aluminum, the present application provides a natural wooden trim component and a method for manufacturing a composite structure with cover configured to provide a natural wood trim component. According an exemplary embodiment, a natural wooden trim component is provided comprising a base layer, a wood veneer layer, and a paint layer arranged (in an assembly/combination); the natural wood decorative component further comprises a metallic gloss layer, and the metallic gloss layer is an ink transfer layer or a PVD spray coating layer. According to an exemplary embodiment, the ink transfer layer is located above the paint layer. According to an exemplary embodiment, the base layer comprises an opaque plastic/resin substrate layer and/or a plastic/resin transparent layer. According to an exemplary embodiment, when the base layer is an opaque plastic/resin substrate layer, the metallic gloss layer is located above the base layer. According to an exemplary embodiment, when the base layer comprises a plastic/resin transparent layer, the metallic gloss layer is located above or below the base layer. In part/component, the metallic gloss layer is at least partially located in a region corresponding to the plastic/resin transparent layer. According to an exemplary embodiment, the wood veneer layer has a mask/shielding layer. According to an exemplary embodiment, when the base layer comprises a plastic/resin substrate layer and a plastic/resin transparent layer, the metallic gloss layer is located above or below the plastic/resin transparent layer, in part directly above or directly below. According to an exemplary embodiment, the plastic/resin transparent layer is located inside the plastic/resin substrate layer in the light-transmitting region. According to an exemplary embodiment, the wood veneer layer is a common wood veneer layer or a light-transmitting wood veneer layer. According to an exemplary embodiment, when the wood veneer layer is an opaque common wood veneer layer, the metallic gloss layer is located above the ordinary wood veneer layer or the ordinary wood veneer layer is of a hollowed-out structure in the light-transmitting region.

According to an exemplary embodiment, the appearance effect of each color metal is reflected by the ink transfer layer or the PVD spray coating layer, and the metal color spray processing technology and the composite structure with cover configured to provide a natural wood trim component are used in combination in the inner and outer trim components of the vehicle, so that the appearance effect of each color metal is achieved without the use of a true metal material. According to an exemplary embodiment the natural wooden trim component may also support a light-transmitting function, which is not less than that of a conventional ground metal, and meets the automotive interior trim requirement of a multi-atmosphere lamp effect.

According to an exemplary embodiment as indicated schematically in FIGS. 45, 46, 47 and 48, the method for manufacturing the natural wooden trim component includes providing a base layer on the back side of the wood veneer layer; providing a paint layer on the upper surface of the wood veneer layer; and providing a metallic gloss layer in an ink-transfer or PVD-spray manner. According to an exemplary embodiment, the method may comprise: performing a first insert injection molding on the back side of the wood veneer layer to provide a plastic/resin substrate layer; and performing a second insert injection molding on the back side of the wood veneer layer to provide a plastic/resin transparent layer. According to an exemplary embodiment, performing the first or second insert injection molding may be performed with non-transparent plastic/resin. According to an exemplary embodiment, the method comprises, prior to providing the base layer, integrally hot pressing the wood veneer layer out of the desired shape. According to an exemplary embodiment, the method comprises: laser carving the wood veneer layer. According to an exemplary embodiment, the method includes CNC milling a part/component edge after providing the base layer to remove the process edge. According to an exemplary embodiment, the method comprises grinding an upper surface of the wood veneer layer before providing the paint layer. According to an exemplary embodiment, the method comprises cutting the wood veneer layer; and/or shading the wood veneer layer.

### Embodiment 1

According to an exemplary embodiment, the natural wooden trim component may be a low-fit version without light transmission, which sequentially includes, from top to bottom, a metallic gloss layer 1, a paint layer 2, a wood veneer layer 3, and a base layer 4 without a light-transmitting true-wood trim component, which may be understood as that the component comprising the composite structure does not have a light-emitting or light-transmitting effect.

According to an exemplary embodiment, the metallic gloss layer 1 may be an ink transfer layer, which may reflect the appearance effect of each color metal. The metallic gloss layer may also be a PVD spray coating layer.

According to an exemplary embodiment, the wood veneer layer 3 is a common wood veneer layer. A “common wood veneer layer” may be understood as a general skin layer that does not necessarily have a light transmittance. The common wood veneer layer is relatively opaque with respect to the light-transmitting wood veneer layer.

According to an exemplary embodiment, the base layer 4 is a plastic/resin substrate layer 41, which can be used to ensure the skeleton strength of the whole product. The plastic/resin substrate layer 41 may be non-transparent, for example black and configured to act as a masking layer simultaneously.

According to an exemplary embodiment, the specific manufacturing method of the natural wooden trim component may include in step S1, the overall hot pressing of the ordinary wood veneer layer is molded out of the desired irregular shape, thereby providing the wood veneer layer 3 in step S2, and providing the base layer 4 on the back surface of the wood veneer layer 3 (the lower surface) by injection molding the non-transparent plastic/resin to provide the part/component composed of the wood veneer layer 3 and the base layer 4. In step S3, the CNC milling a part/component edge to remove the process edge. In step S4, the exterior surface/side of the wood veneer layer 3 (the upper surface) may be polished as a whole. In step S5, after the paint layer 2 is provided on the A-side of the wood veneer layer 3 by means of a full-set paint process, the wood grain catheter of the wood veneer layer 3 is fully filled, and the flatness of the surface is sufficient. In step S6, the metallic color ink is transferred to the exterior surface/side; the paint layer 2, of the wood veneer layer 3 to provide the metallic gloss layer 1 thereby forming the appearance effect of the wood grain metal color.

According to an exemplary embodiment, the common wood veneer layer may be first cut into the required size and shape in step S0. Alternatively, a common wood veneer layer that has been cut to a desired size and shape may be provided in step S0.

According to an exemplary embodiment, the metallic gloss layer 1 may be provided by means of PVD spraying in step S6.

According to an exemplary embodiment, where the wood veneer layer 3 is sufficiently smooth, the metallic gloss layer 1 may be provided between the paint layer 2 and the wood veneer layer 3; the metallic gloss layer 1 can be additionally protected by means of the paint layer 2.

### Embodiment 2

According to an exemplary embodiment, the natural wooden trim component according to the present embodiment may be a high-fit version with light transmission. The light-transmitting natural wooden trim component may have a light-emitting or light-transmitting effect.

According to an exemplary embodiment, the natural wooden trim component includes, from top to bottom, a metallic gloss layer 1, a paint layer 2, a wood veneer layer 3, and a base layer 4, which are different from Embodiment 1. The base layer 4 includes a plastic/resin substrate layer 41 and a plastic/resin transparent layer 42, and the plastic/resin transparent layer 42 may be located directly below the metallic gloss layer 1 in the light-transmitting region. A bottom light element may be provided below the vacuum trim component, the bottom light element may emit light, and the emitted light may pass through the plastic/resin transparent layer 42 and the wood veneer layer 3 to refract the light-transmitting metal by means of the metallic gloss layer 1. According to an exemplary embodiment, the plastic/resin transparent layer 42 may be located inside the plastic/resin substrate layer 41.

According to an exemplary embodiment, the metallic gloss layer 1 may be an ink transfer layer, which is a semi-transparent layer, and when light is closed, the static metal effect is displayed, the internal structure is shielded, and when bright light, the metal effect is lit.

According to an exemplary embodiment, the wood veneer layer 3 is a light-transmitting wood veneer layer. The full-light-transmitting wood veneer layer provides the natural wood skin appearance texture effect. The “light-transmitting wood veneer layer” may be understood as a wood veneer layer with a certain light transmittance.

According to an exemplary embodiment, the plastic/resin substrate layer 41 acts as a masking layer which provides a high light transmittance. The plastic/resin substrate layer 41 may be non-transparent, for example black.

According to an exemplary embodiment, the specific manufacturing method of the natural wooden trim component may include in step S1, the overall hot-press molding of the light-transmitting wood veneer layer out of the desired irregular shape, so as to provide the wood veneer layer 3 in step S2a, which may provide the plastic/resin substrate layer 41 on the back surface of the wood veneer layer 3, in the desired non-light-transmitting region first sub-insert, so as to form the shielding layer in the non-light-transmitting region. In step S2b, the plastic/resin transparent layer 42 may be provided on the back side of the wood veneer layer 3 by injection molding the transparent plastic/resin so that the plastic/resin transparent layer 42 fills the back of the desired light transmission area and forms an integral base layer 4 with the plastic/resin substrate layer 41 to obtain the part/component composed of the wood veneer layer 3 and the base layer 4. According to an exemplary embodiment, the component comprising the composite structure may be understood that steps S2 an and S2b need not have a specific order, so step S2b may also be implemented before step S2a. In step S3, the CNC milling a part/component edge to remove the process edge. In step S4, the exterior surface/side of the wood veneer layer 3 may be integrally polished. In step S5, after the paint layer 2 is provided with the paint layer 2 by means of a whole paint process, the wood grain catheter of the wood veneer layer 3 is fully filled, and the flatness of the surface is sufficient. In step S6, the metal color ink is transferred to the A-plane light-transmitting region of the wood veneer layer 3 (above the paint layer 2) to provide the metallic gloss layer 1, and since the metallic gloss layer 1 has a certain transmittance, the appearance effect of the wood grain combined with the metal color light transmission is formed.

According to an exemplary embodiment, the light from the light element may pass through the wood veneer layer 3 and the metallic gloss layer 1 in sequence, so that in the case where the light element is lit, not only the metal effect can be developed in the light-transmitting region, but also a wood grain effect can be presented.

Since the printing ink has a certain requirement on the flatness of the surface of the product, in order to reduce the shielding of the texture of the ink metal by the paint layer 2, this embodiment places the ink transfer layer above the paint layer 2.

According to an exemplary embodiment, the metallic gloss layer 1 may be provided between the paint layer 2 and the wood veneer layer 3. This is for example applicable to a case where the wood veneer layer 3 is sufficiently smooth and that the paint layer 2 is transparent.

According to an exemplary embodiment, the metallic gloss layer 1 may be provided by means of PVD spraying in step S6

According to an exemplary embodiment, the transparent wood veneer layer may be first cut into the required size and shape in step S0. Alternatively, a transparent wood veneer layer that has been cut to a desired size and shape may be provided in step S0.

### Embodiment 3

According to an exemplary embodiment, the natural wooden trim component according to this embodiment may be a high-fit version with light transmission. Similar to Embodiment 2, the natural wooden trim component may sequentially include a metallic gloss layer 1, a paint layer 2, a wood veneer layer 3, and a base layer 4 from top to bottom in that the wood veneer layer 3 forms a hollow structure in the light-transmitting region.

According to an exemplary embodiment, the metallic gloss layer 1 may be a PVD spray coating layer, which may reflect the appearance effect of each color metal. The metallic gloss layer 1 may also be an ink transfer layer.

According to an exemplary embodiment, the wood veneer layer 3 may be a common wood veneer layer.

According to an exemplary embodiment, the specific manufacturing method of the natural wooden trim component may include in step S1, the overall hot-press molding of the common wood veneer layer out of the desired profiled shape, so as to provide the wood veneer layer 3 in step S2a, which may provide the plastic/resin substrate layer 41 on the back side of the wood veneer layer 3, in the desired non-light-transmitting region first sub-insert, so as to form the shielding layer in the non-light-transmitting region. In step S7, in the light-transmitting region, the wood veneer layer 3 on the required shape may be laser engraved in a laser carving mode, and in step S2b, the plastic/resin transparent layer 42 may be provided on the back side of the wood veneer layer 3 by injection molding the transparent plastic/resin, so that the plastic/resin transparent layer 42 fills the back surface of the required light-transmitting region and forms an integral base layer 4 with the plastic/resin substrate layer 41 to obtain the part/component composed of the wood veneer layer 3 and the base layer 4. In step S3, the CNC milling a part/component edge to remove the process edge. In step S4, the exterior surface/side of the wood veneer layer 3 may be integrally polished. In step S5, the paint layer 2 may be provided with the paint layer 2 to finally perform PVD spraying of the surface A of the skin layer 3 in step S6 (especially on the paint layer 2) to provide the metallic gloss layer 1. Since the metallic gloss layer 1 has a certain transmittance, the appearance effect of the wood grain combined with the metal color light transmission is formed.

According to an exemplary embodiment, since the wood veneer layer 3 is hollow in the light-transmitting region, the light from the light element may only penetrate through the metallic gloss layer 1, and therefore, in the case where the light element is lit, the light-transmitting region may only show the light-transmitting metal effect.

According to an exemplary embodiment, especially in the case that the wood veneer layer 3 is a light-transmitting wood veneer layer, the wood veneer layer 3 may only be partially hollowed out in the light-transmitting region; when the light element is lit, in the light-transmitting region, the non-hollowed-out region of the wood veneer layer 3 may similarly exhibit a light-transmitting wood grain and a metal superposition effect as in Embodiment 2, and the hollowed-out region of the wood veneer layer 3 may only exhibit a light-transmitting metal effect.

According to an exemplary embodiment, the metallic gloss layer 1 may be provided by means of metallic color ink transfer in step S6

According to an exemplary embodiment, the wood veneer layer may be first cut into a desired size and shape in step S0. Alternatively, a wood veneer layer that has been cut to a desired size and shape may be provided in step S0.

### Embodiment 4

According to an exemplary embodiment, the natural wooden trim component according to the present embodiment may be a high-fit version with light transmission. The difference from Example 3 is only that the metallic gloss layer 1 is located below the plastic/resin transparent layer 42. Embodiment 4 may prevent the metallic gloss layer 1 from being scratched relative to Embodiment 3. According to an exemplary embodiment, the trapezoidal design of the plastic/resin transparent layer 42 may increase the bonding area of the plastic/resin substrate layer 41 with the plastic/resin transparent layer 42 to increase the bonding force of the secondary injection molding.

According to an exemplary embodiment, the wood veneer layer 3 may only be partially hollowed out in the light-transmitting region; when the light element is lit, in the light-transmitting region, the hollowed-out region of the wood veneer layer 3 may only exhibit a light-transmitting metal effect, and the non-hollowed-out region of the wood veneer layer 3 may maintain a substantially non-light-transmitting wood grain effect. In some other embodiments, if the wood veneer layer 3 is a light-transmitting wood veneer layer, in a light-transmitting region, the non-hollowed-out region of the wood veneer layer 3 may display a light-transmitting wood grain effect in the light-transmitting region.

According to an exemplary embodiment, since the metallic gloss layer 1 is located below the plastic/resin transparent layer 42, step S6 of providing the metallic gloss layer 1 does not have to be performed after step S5 of providing the paint layer 2, provided that step S6 is after the step S2b of providing the plastic/resin transparent layer 42.

### Embodiment 5

According to an exemplary embodiment, the natural wooden trim component according to this embodiment may be a high-fit version with light transmission. The difference from Embodiment 4 is only that the plastic/resin substrate layer 41 of the non-light-transmitting area is replaced with a plastic/resin transparent layer 42 to provide an integrally light-transmitting base layer 4, while the wood veneer layer 3 needs to increase the shading. In this way, the specific manufacturing method of the natural wooden trim component may be referred to the manufacturing method described in combination with Embodiment 4, but here only the transparent plastic/resin need to be injection-molded at the back of the wood veneer layer 3 to provide the base layer 4, the step S2a of the plastic/resin substrate layer 41 may be omitted, but only the entire plastic/resin transparent layer 42 provided in step S2b as a whole light-transmitting base layer 4 metallic gloss layer 1 is located below the transparent base layer 4, so that the metal gloss is seen through the paint layer 2 and the base layer 4. According to an exemplary embodiment, the shading effect of Example 4 can be achieved by adding shading to the wood veneer layer 3, and compared with Example 4, when providing the base layer 4, the monochrome injection molding can be used instead of dual-color injection molding, and the cost is better.

### Embodiment 6

According to an exemplary embodiment, the natural wooden trim component according to this embodiment may be a high-fit version with light transmission. The difference from Example 5 includes that the metallic gloss layer 1 is directly below the paint layer 2. According to an exemplary embodiment, the specific manufacturing method of the natural wooden trim component may after CNC milling (step S3), first perform the transfer printing or PVD on the exterior surface/side to provide the metallic gloss layer 1 (step S6) to provide the paint layer 2 (step S5).

According to an exemplary embodiment, the wood veneer layer 3 may include a wood skin, an adhesive layer, and a base layer, and is usually used as a base layer of the wood veneer layer 3. According to an exemplary embodiment, if the base layer 4 is provided as a transparent layer as in Embodiment 6, the shading performance of the wood veneer layer may be correspondingly improved, and the selected manner may be to perform shading optimization processing on the wood veneer layer to increase the shielding layer. According to an exemplary embodiment, a light shielding material or a light shielding layer may be applied on the back side of the wood veneer layer 3.

### Exemplary Embodiments—D

According to an exemplary embodiment, an improved vehicle interior component may comprise a composite structure comprising a cover comprising a natural wood trim comprising a base layer, a wood veneer layer and a paint layer arranged (in an assembly/combination); the natural wood trim further comprises a metal luster layer, the metal luster layer being an ink pad printing layer or a PVD spraying layer. According to an exemplary embodiment, the component may comprise a composite structure comprising a natural wood trim, the metallic appearance effects of various colors can be achieved by means of the ink pad printing layer or the PVD spraying layer, and the metal color spraying treatment technology and the natural wood trim can be combined and applied to interior and exterior trims of automobiles, thereby achieving the embedded multi-color metallic appearance effects at a low material cost without using natural metal materials. According to an exemplary embodiment, the component may comprise a composite structure produced by an improved method. See FIGS. 45, 46, 47 and 48.

According to an exemplary embodiment, the component may comprise a composite structure comprising a cover comprising a visual appearance of wood grain with metallic color trim strips integrated with light-transmitting natural wood trim; the composite structure comprising the cover may be configured to provide a decorative component with the appearance effect of the natural wood-embedded aluminum with improved efficient material and production costs; the composite structure may be provided for vehicle interior components for a wide range of vehicles with cost efficient quality/appearance.

According to an exemplary embodiment, a method for making natural wood decorative part/components with light transmission integrated with wood grain and metal color decorative strips for automobiles is disclosed. Metallic decorative strips are integrated on natural wood part/components, without assembly, and the metal trim strips can transmit light, so as to achieve the novel appearance effect of natural wood embedded with natural metal and light transmission. According to an exemplary embodiment, the component may comprise a composite structure comprising a cover comprising a regular/natural wood interior with a surface effect comprising a visual effect comprising an improved/novel appearance.

According to an exemplary embodiment, the component may comprise a composite structure comprising a natural wood combined with metallic pad printing with light-transmitting decorations, including: paint layer, metallic ink layer, light-transmitting wood veneer layer, plastic/resin substrate layer, transparent plastic/resin layer. The metallic ink layer reflects the appearance effect of various metals, and the principle of light transmission: the light element at the bottom of the part/component emits light, through the transparent plastic/resin layer and the light-transmitting wood veneer layer, and through the metallic ink layer, the effect of light-transmitting metal is refracted.

Layer structure may comprise: (with light transmission) metallic ink layer-paint layer-wood veneer layer-plastic/resin substrate layer-transparent plastic/resin layer, the overall hot-pressing of the light-transmitting wood veneer layer is formed to create the required special-shaped shape; The first insert on the back of the veneer is injected into the non-transparent plastic/resin to form a shielding layer in the non-light-transmitting area. The second back insert is injected into the transparent plastic/resin to fill the back of the desired light-transmitting area, and the substrate forms a whole; CNC milling the edge of the part/component to remove the runoff edge; The overall polishing of the exterior surface/side, a full set of painting processes; After the topcoat, the wood grain duct is fully filled, the surface flatness is sufficient, and then the metallic ink is pad printed on the light transmission area of the exterior surface/side, and the metallic ink has a certain transmittance, which forms the appearance effect of wood grain combined with metallic light transmission. Through secondary injection molding, the transmitted and opaque areas are formed. The overall decorative layer is formed through the wood veneer layer and paint layer with a certain transmittance. Through ink pad printing, cover a layer of metallic color on the light-transmitting area to ensure that the metallic decorative effect is still maintained when the light is closed.

Layer structure may comprise: (configuration without light transmission) metallic ink layer-paint layer-wood veneer layer-plastic/resin substrate layer, the ordinary wood veneer layer as a whole is hot-pressed to form the required special-shaped shape; The back of the veneer is injected with non-transparent plastic/resin; CNC milling the edge of the part/component to remove the runoff edge; The overall polishing of the exterior surface/side, a full set of painting processes; After the topcoat, the wood grain duct is fully filled, the surface is flat enough, and then the metallic ink is pad-printed on the exterior surface/side, forming the appearance effect of wood grain inlaid metallic color. By one injection molding, there is no light transmission area. The wood veneer layer and paint layer without light transmission function form an overall decorative layer. Through ink pad printing, metallic decorative patterns are directly formed on the surface. Features of the composite structure may comprise: Metallic ink pad printing (or other metal color coating) combined with translucent natural wood interior part/components.

Traditional natural wood decorative part/components are embedded with metal effects, all in the form of wood extrusion aluminum, and the hierarchical structure is directly embedded with natural aluminum sheets under the natural wood, which is difficult to process and costly, and the component comprising the composite structure is difficult to be widely promoted and used. According to an exemplary embodiment, the component may comprise a composite structure comprising a decorative part/component with a production method and hierarchical process design in the hierarchical structure of natural wood part/components for automobiles combined with metal color coating treatment technology (metallic ink pad printing, metallic PVD diaphragm, metallic PVD coating, i.e., vacuum evaporation coating and other surface treatment technologies) to achieve the appearance effect of natural wood inlayed metal and light transmission. There is no natural metal material, but the component comprising the composite structure has a metallic appearance effect, reducing the direct material cost; Multi-scheme metal color coating may be combined with the process to reduce the cost of the production process; According to an exemplary embodiment, the component comprising the composite structure supports light transmission function to meet the needs of automotive interiors with multi-atmosphere lighting effects.

TABLE A
REFERENCE SYMBOL LIST

| REFERENCE | |
|---|---|
| SYMBOL | ELEMENT, part/component OR COMPONENT |
| V | Vehicle |
| VI | Vehicle interior |
| C | Component |
| CS | Composite structure |
| SB | Substrate/base (e.g. structural substrate, carrier, etc.) |
| T | Cover |
| TB | Base layer of cover |
| TX | Cover layer of cover (e.g. exterior surface) |
| TW | Wood/veneer layer (e.g. natural wood, artificial wood, |
| | etc.) |
| TL | Light-transmissive wood/veneer layer (e.g. natural wood, |
| | artificial wood, etc.) |
| TN | Intermediate layer (e.g. barrier layer, membrane, etc.) |
| TP | Coating (e.g. paint layer/coating as applied) |
| TV | Coating (e.g. PVD layer, coating, etc.) |
| TK | Deposit (e.g. ink layer, coating, etc.) |
| TG | Light guide/light-transmissive material |
| TM | Mask (e.g. mask/shield layer, opaque material, etc.) |
| TD | Trim strip/line (e.g. decorative strip, decorative line, |
| | illuminated line, etc.) |
| TR | Trim (e.g. edge, trim rail, etc.) |
| FL | Light-transmitting region/light-transmitting feature |
| LS | Light source (e.g. light panel, LED lamp/array, etc.) |
| IP | Instrument panel/assembly |
| DP | Door panel |
| FC | Floor console |
| GB | Receptacle/storage |
| AR | Armrest/armrest assembly |
| VN | Visor/vanity panel/flap |
| NKF | Frunk |
| NKR | Trunk |
| OHC | Overhead console |
| OHP | Overhead panel |
| PL | Pillar |
| PN | Panel |
| SW | Steering wheel/assembly |
| SZ | Seat/seat assembly |
| M | Module |
| WT | Liquid/liquid drops |
| ZF | Force-applying tool/object |
| MT | Tool |
| MX | Tool (e.g. spray head, transfer tool, ink pad tool, etc.) |
| MD | Device |
| OB | Object |
| 1 | Cover layer (e.g. metallic layer, gloss layer, ink, coating, |
| | etc.) |
| 2 | Cover layer (e.g. coating, film, paint layer, etc.) |
| 3 | Cover (e.g. cover layer, base layer, wood material, |
| | veneer layer, etc.) |
| 4 | Base layer |
| 41 | Base/substrate layer |
| | (e.g. cover substrate, plastic/resin substrate layer, etc.) |
| 42 | Base/substrate layer |
| | (e.g. cover substrate, light-transmissive layer, plastic/ |
| | resin transparent layer, etc.) |

According to an exemplary embodiment, the component comprising the composite structure is important to note that the present embodiments (e.g. inventive concepts, etc.) have been described in the specification and/or illustrated in the FIGURES of the present patent document according to exemplary embodiments; the embodiments of the present embodiments are presented by way of example only and are not intended as a limitation on the scope of the present embodiments. The construction and/or arrangement of the elements of the inventive concepts embodied in the present embodiments as described in the specification and/or illustrated in the FIGURES is illustrative only. Although exemplary embodiments of the present embodiments have been described in detail in the present patent document, a person of ordinary skill in the art will readily appreciate that equivalents, modifications, variations, etc. of the subject matter of the exemplary embodiments and alternative embodiments are possible and contemplated as being within the scope of the present embodiments; all such subject matter (e.g. modifications, variations, embodiments, combinations, equivalents, etc.) is intended to be included within the scope of the present embodiments. According to an exemplary embodiment, the component comprising the composite structure should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present embodiments; all such subject matter (e.g. modifications, variations, embodiments, combinations, equivalents, etc.) is intended to be included within the scope of the present embodiments. The scope of the present embodiments is not intended to be limited to the subject matter (e.g. details, structure, functions, materials, acts, steps, sequence, system, result, etc.) described in the specification and/or illustrated in the FIGURES of the present patent document. According to an exemplary embodiment, the component comprising the composite structure is contemplated that the claims of the present patent document will be construed properly to cover the complete scope of the subject matter of the present embodiments (e.g. including any and all such modifications, variations, embodiments, combinations, equivalents, etc.); the component comprising the composite structure is to be understood that the terminology used in the present patent document is for the purpose of providing a description of the subject matter of the exemplary embodiments rather than as a limitation on the scope of the present embodiments.

According to an exemplary embodiment, the component comprising the composite structure is also important to note that according to exemplary embodiments the present embodiments may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present embodiments of the present patent document.

The invention claimed is:

1. A component for a vehicle interior comprising: a composite structure comprising a cover;
wherein the cover comprises a base layer and a cover layer;
wherein the cover layer is configured to provide an exterior surface for the cover;
wherein the cover is configured to provide a surface effect for the exterior surface;
wherein the surface effect comprises a visual effect and/or a performance effect;
wherein the surface effect is provided at the exterior surface of the cover and/or under the exterior surface of the cover;
wherein the visual effect comprises a decorative effect for the cover;
wherein the cover comprises a material comprising an applied material and/or a deposited material and/or a coating and/or a paint and/or an ink material and/or a deposited material and/or a film.

2. The component of claim 1 wherein the base layer comprises a wood material and/or a veneer and/or a wood veneer.

3. The component of claim 1 further comprising a light source configured to provide illumination at the cover of the composite structure; wherein the cover comprises a light guide and/or a light-transmissive material.

4. The component of claim 1 wherein the base layer comprises a light-transmissive material comprising a wood veneer material.

5. The component of claim 1 wherein the composite structure comprises a substrate for the cover.

6. The component of claim 1 wherein the cover comprises a feature configured to provide the surface effect; wherein the feature comprises a line and/or a strip and/or a layer and/or a trim strip and/or a trim line and/or a decorative feature and/or a decorative line and/or an inlaid material and/or a set of lines and/or a set of strips and/or a set of layers and/or a set of trim strips and/or a set of trim lines.

7. The component of claim 6 wherein the feature comprises a layer of material and/or an applied material and/or a deposit of material.

8. The component of claim 6 wherein the feature comprises a decorative feature at the cover layer of the cover and/or on the exterior surface of the cover and/or within the cover and/or on the base layer of the cover and/or under the base layer of the cover and/or a decorative feature configured to be illuminated by a light source and/or a trim strip and/or a decorative line and/or a trim line configured to be illuminated by a light source.

9. The component of claim 1 wherein the visual effect comprises an illumination effect and/or a color effect and/or a gloss effect and/or a luster effect and/or a dynamic decorative effect and/or an illumination effect and/or a dynamic illumination effect and/or a texture effect and/or a grain effect and/or a gloss effect and/or a contrast effect and/or a wood grain effect and/or a metallic effect and/or a trim strip effect and/or a divider line effect and/or an inlaid appearance effect and/or a metal-like appearance effect and/or a wood-like appearance effect and/or an embedded metallic appearance effect.

10. The component of claim 1 wherein the decorative effect comprises a static effect and/or a dynamic effect and/or a texture effect and/or a color effect and/or a luster effect and/or a gloss effect and/or a matte effect and/or a grain effect and/or a wood grain effect and/or a metal effect and/or a metallic texture effect.

11. The component of claim 1 wherein the performance effect comprises protection for the exterior surface and/or a tactile effect and/or a texture effect.

12. The component of claim 1 wherein the cover comprises a paint layer and/or a coating layer and/or a PVD layer and/or an ink layer and/or a light-transmissive layer and/or a mask layer and/or an opaque layer.

13. The component of claim 1 wherein the cover comprises at least one facet at the exterior surface configured to provide a visual effect and/or at least one section at the exterior surface configured to provide a plurality of visual effect.

14. The component of claim 13 wherein the cover comprises a feature between each facet of the exterior surface and/or each section of the exterior surface; wherein the feature comprises a trim strip and/or a divider line.

15. The component of claim 1 wherein the base layer comprises a molded layer comprising a polymer material and/or a molded material and/or an injection molded material and/or a film and/or a polymer material and/or an elastomer and/or a thermoresin elastomer and/or a resin layer and/or a substrate section and/or a structural section and/or a light-transmissive section and/or an opaque section and/or a non-light-transmissive section and/or an opaque section and a light-transmissive section and/or a resin substrate layer and/or an opaque resin substrate layer.

16. The component of claim 1 wherein the decorative effect of the cover comprises a metallic decorative effect and/or a wood grain effect.

17. The component of claim 1 wherein the cover layer of the cover comprises a coating and/or an ink layer and/or a coating layer and/or a treatment layer and/or a protective layer and/or a light-transmissive coating layer and/or a paint layer and/or an ink layer and/or a PVD layer and/or a gloss layer and/or a color gloss layer and/or a metal color layer and/or a metallic ink layer and/or a printed metallic ink layer.

18. The component of claim 1 wherein the cover is configured to provide the visual effect as an ambient effect when cover is unilluminated by a light source and the visual effect as an illuminated effect when the cover is illuminated by a light source.

19. The component of claim 1 wherein surface effect of the composite structure is configured to comprise a wood grain effect and/or a gloss effect when unilluminated by a light source and a metallic effect and/or a reflective effect when illuminated by a light source.

20. The component of claim 6 produced by a method comprising the steps of: providing a base layer material for the base layer of the cover; providing a cover layer material for the cover layer of the cover on the base layer of the cover; providing the feature for the cover; wherein the step of providing the cover layer material on the base layer comprises forming the cover layer on the base layer; wherein the cover layer material comprises at least one of a coating and/or a paint layer and/or an ink layer and/or a PVD material and/or a deposited material and/or an applied material and/or a spray-applied material; wherein the cover is configured to provide the surface effect for the composite structure; wherein the feature comprises a trim line configured to provide the decorative effect for the cover.
